(19) United States
(12) Patent Application Publication
(10) Pub. No.: US 2007/0022208 A1
(43) Pub. Date: Jan. 25, 2007

(54) RECORDING AND REPRODUCTION APPARATUS

(75) Inventors: Satoshi HASHIMOTO, Osaka (JP); Takaaki SUZUKI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/428,631

(22) Filed: Jul. 5, 2006

Related U.S. Application Data
(60) Provisional application No. 60/696,503, filed on Jul. 6, 2005.

(51) Int. Cl. G06F 15/16

(52) U.S. Cl. 709/231

(57) ABSTRACT

A recording and reproduction apparatus shifts a program which is currently being executed to a paused state, or temporarily shifts a mode of graphics drawing by an application program to an invisible mode, in order to reproduce a recorded video with trick play functionality at a reproduction speed different from a normal reproduction speed, thereby making it possible to prevent an unexpected behavior of the program even when an application program is executing a time-consuming process.

### CROSS REFERENCE TO RELATED APPLICATION

This application claims the benefit of U.S. Provisional Application No. 60/696503 filed Jul. 6, 2005, the contents of which are herein incorporated by reference in its entirety.

### BACKGROUND OF THE INVENTION

(1) Field of the Invention

The present invention relates to a recording and reproduction apparatus which accumulates contents and reproduces the accumulated contents. In particular, the present invention relates to a setup for receiving a broadcast wave including content made up of video and audio as well as data such as a program that are multiplexed into the broadcast wave in synchronization with each other and transmitted, and for accumulating the video, audio and data, as well as a setup for executing trick play such as fast-forward and rewind of the content while maintaining synchronization between the video and audio and the data such as a program.

(2) Description of the Related Art

Various contents are included in a broadcast wave sent from a broadcast station, Aside from video and audio used in a normal TV show, there are cases where data is included in the contents. There are several methods for sending the data, which can be roughly divided into a method of sending the data chronologically and a method of repeatedly sending the data per set interval. In the former method of sending the data chronologically, for example, data that continues over the course of time is sent in sequential order. This method is suitable for sending large amounts of data over a long period of time, but there is a drawback in that data that could not be received at the timing of the sending cannot be received again. On the other hand, in the latter method of repeatedly sending the data at a set interval, the same data is repeatedly sent any number of times during a fixed period. This method has an advantage in that during the period when the same data is being sent, it is acceptable to receive any one of the repeatedly-sent pieces of data, and thus the timing of receiving is not limited.

Data broadcast, represented by BML, and file sending through DSM-CC data carousel are examples of this method. It is unknown, particularly in broadcast, when a recipient will select a channel and commence reception. In the method of sending the data chronologically, when the start of reception falls behind the timing of the sending and thus acquisition of the data, the data cannot be re-acquired. Therefore, when sending data such as an application program along with video and audio in the broadcast wave, the method of repeatedly sending the data per set interval is favorable.

At present, specifications for receiving a broadcast wave that includes video, audio, and an application program and for executing the application program in synchronization with video and audio, as in the above method, have been developed, and are in operation. It is possible to receive the sent application program, load the application program into a terminal, and realize various extra functions by executing the application program, rather than simply viewing the video and audio.

This method for sending the application program and loading the application program into the terminal is also called “downloading”. For example, a specification called Digital Video Broadcasting—Multimedia Home Platform (DVB-MHP) ETSIES201812 v1.1.1 (2003-12) has been developed in Europe, and operations according to this specification have already commenced. In addition, Open Cable Application Platform (OCAP) OC-SP-OCAP1.0-I14-050119 specification, which provides the same framework in the cable broadcast environment, is being developed in the United States, and actually operations are set to commence. In these specifications, the application program is written in the Java language. Various Application Programming Interfaces (APIs) for tuning, graphics display, and the like are provided in the terminal, and the Java application program can control those functions by calling the APIs.

In addition, in North America, the OCAP-DVROC-SP-OCAP-DVR-I01-040524 specification, which is aimed at adding a function for recording and reproducing the contents in the OCAP specification, is being developed. With this specification, the video, audio, and the Java application program executed in synchronization with each other, which are sent as a cable television broadcast, are recorded as a content, and furthermore, are reproduced in the same manner as when the recorded content is directly reproduced from the broadcast wave. The application program is reproduced in synchronization with the video and audio, in the same manner as direct reproduction from the broadcast wave,

Moreover, with OCAP-DVR, trick play of the contents is realized by recording broadcast contents on a high-speed random-accessible storage medium, such as a hard disk, a semiconductor memory, and the like. Here, the trick play refers to functions for reproducing the contents at an arbitrary speed, from an arbitrary position, and so on, such as fast-forward, rewind, slow-motion, pause, skip, and the like. With OCAP-DVR, the application program loaded into the terminal from the broadcast wave can control the recording and trick play of the content. In other words, APIs for recording and trick play are provided in the terminal, and the Java application program controls each function by calling those APIs.

Typically, control information for synchronization is in advance multiplexed into a broadcast wave in order to execute an application program in synchronization with video and audio. The application programs are executed and terminated one by one in accordance with the synchronization control information. Therefore, it is possible to switch to a suitable application program to be executed for a particular scene of video and audio.

In addition, according to the OCAP-DVR specification and the like, during reproduction of a recorded content with trick play functionality, a terminal needs to execute an application program in synchronization with reproduction of video and audio. For example, in the case where a terminal fast-forwards a content, it needs to execute start/termination processing of an application program, graphics drawing processing by the application program, and the like, at an appropriate timing in accordance with the reproduction speed of the content.

As mentioned above, according to the OCAP-DVR specification and the like, during reproduction of a recorded content with trick play functionality, a terminal needs to execute an application program in synchronization with reproduction of video and audio.

However, in some cases, it is difficult for the terminal to execute the application program in synchronization with the trick play of the video and audio of the recorded content. For example, in the case where a terminal fast-forwards a recorded content, it is generally difficult to execute start/termination processing of an application program, graphics drawing processing by an application program, and the like, at an appropriate timing in accordance with the reproduction speed of the video and audio. Typically, an application program includes such time-consuming processings to be executed. In addition, in the case where an application program is executed on a terminal with low processing speed, start/termination processing of the application program and graphics drawing processing by the application program, for example, are delayed, which triggers an unexpected behavior of the application program.

In order to solve the above-mentioned problem, it is an object of the present invention to provide a recording and reproduction apparatus for controlling unexpected behaviors of an application program, even if a terminal needs to execute the application program in synchronization with reproduction of video and audio of a recorded content with trick play functionality.

### SUMMARY OF THE INVENTION

In order to achieve the above object, a recording and reproduction apparatus of the present invention includes: a content reproduction unit which reproduces a content recorded on a storage medium; a program execution unit which executes a program and controls a state of the program; a content reproduction speed change unit which changes a reproduction speed of the content based on an instruction from the program which is in an execution state; a trick play detection unit which detects one of the following: that the reproduction speed has been shifted from a normal reproduction speed to a reproduction speed different from the normal reproduction speed; and that the reproduction speed has been shifted from a reproduction speed different from the normal reproduction speed to the normal reproduction speed; and a trick play processing unit which instructs the program execution unit to change the state of the program based on the detection by the trick play detection unit, and the program execution unit controls the state of the program so that the state of the program is shifted to a state instructed by the trick play processing unit.

For example, when the trick play detection unit detects that the reproduction speed has been shifted from the normal reproduction speed to the different reproduction speed, the trick play processing unit instructs the program execution unit to change the state of the program which is in the execution state to a paused state, and the program execution unit pauses the execution of the program so that the state of the program is shifted to the paused state.

As mentioned above, while a terminal is reproducing a recorded content with trick play functionality, an application program is shifted into a paused state. Therefore, it is possible to control unexpected behaviors of the application program. It is also possible to reduce high-load access to a semiconductor memory or the like represented by a hard disk, a Blu-ray Disc (BD), a Digital Versatile Disc (DVD), a Secure Digital (SD) memory card and the like, and to reduce deterioration of such storage media, particularly during fast-forward and rewind.

When the trick play detection unit detects that the reproduction speed has been shifted from the different reproduction speed to the normal reproduction speed, the trick play processing unit may instruct the program execution unit to change the state of the program from the paused state to the execution state, and the program execution unit may resume the execution of the program so that the state of the program is shifted to the execution state.

The trick play processing unit may instruct the program execution unit to change a state of a specific program only, the specific program being identified out of the programs.

The specific program may be identified based on information multiplexed into the content.

The specific program may be identified based on information which has previously been registered by a privileged program out of the programs.

Furthermore, to achieve the above object, a recording and reproduction apparatus of the present invention includes: a content reproduction unit which reproduces a content recorded on a storage medium; a program execution unit which executes a program and controls a state of the program; a graphics display unit which controls a mode of graphics between a visible mode and an invisible mode, the graphics being drawn by the program executed by the program execution unit; a content reproduction speed change unit which changes a reproduction speed of the content based on an instruction from the program; a trick play detection unit which detects one of the following: that the reproduction speed has been shifted from a normal reproduction speed to a reproduction speed different from the normal reproduction speed; and that the reproduction speed has been shifted from a reproduction speed different from the normal reproduction speed to the normal reproduction speed; and a trick play processing unit which instructs the graphics display unit to change the mode of the graphics based on the detection by the trick play detection unit.

For example, when the trick play detection unit detects that the reproduction speed has been shifted from the normal reproduction speed to the different reproduction speed, the trick play processing unit instructs the graphics display unit to change the mode of the graphics from the visible mode to the invisible mode.

As mentioned above, while a terminal is reproducing a recorded content with trick play functionality, graphics drawing by an application program is temporarily deactivated. Therefore, it is possible to control unexpected behaviors of the application program. It is also possible to reduce high-load access to a semiconductor memory or the like represented by a hard disk, a Blu-ray Disc (BD), a Digital Versatile Disc (DVD), a Secure Digital (SD) memory card and the like, and to reduce deterioration of such storage media, particularly during fast-forward and rewind of a content.

When the trick play detection unit detects that the reproduction speed has been shifted from the different reproduction speed to the normal reproduction speed, the trick play processing unit may instruct the graphics display unit to change the mode of the graphics from the invisible mode to the visible mode.

The trick play processing unit may instruct the graphics display unit to change a mode of only graphics drawn by a specific program identified out of the programs.

The specific program may be identified based on information multiplexed into the content.

The specific program may be identified based on information which has previously been registered by a privileged program out of the programs.

The content and the program may be information included in a broadcast wave and recorded onto the storage medium.

Note that the present invention can be implemented not only as the above-mentioned recording and reproduction apparatus but also as a recording and reproduction method, a program for the method and a storage medium for storing the program.

As further information about technical background to this application, the disclosure of U.S. Provisional Application No. 60/696503 filed Jul. 6, 2005, including specification, drawings and claims, is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcast system according to the present invention;

FIG. 2 is a diagram showing one example of how to use a frequency band used in communications between a broadcast station side system and a terminal apparatus, in a cable television system according to the present invention;

FIG. 3 is a diagram showing one example of how to use a frequency band used in communications between a broadcast station side system and a terminal apparatus, in a cable television system according to the present invention;

FIG. 4 is a diagram showing one example of how to use a frequency band used in communications between a broadcast station side system and a terminal apparatus, in a cable television system according to the present invention;

FIG. 5 is a configuration diagram of a TS packet predefined by MPEG-2 specifications;

FIG. 6 is a schematic diagram of an MPEG-2 transport stream;

FIG. 7 is a diagram showing an example of division when a PES packet predefined by MPEG-2 specifications is carried in TS packets;

FIG. 8 is a diagram showing an example of division when an MPEG-2 section predefined by MPEG-2 specifications is carried in TS packets;

FIG. 9 is a configuration diagram of an MPEG-2 section predefined by MPEG-2 specifications;

FIG. 10 is a diagram showing an example of use of an MPEG-2 section predefined by MPEG-2 specifications;

FIG. 11 is a diagram showing an example of use of a PMT predefined by MPEG-2 specifications;

FIG. 12 is a diagram showing an example of use of a PAT predefined by MPEG-2 specifications;

FIG. 13 is a diagram showing a configuration example of a hardware configuration of a broadcast recording and reproduction apparatus according to the present invention;

FIG. 14 is a diagram showing an example of a front panel of an input unit 1310 in a hardware configuration of a terminal apparatus 1200 according to the present invention;

FIG. 15 is a diagram showing an example of a device connection at the time of recording, in the recording and reproduction apparatus according to the present invention;

FIG. 16 is a diagram showing an example of a device connection at the time of reproduction, in the recording and reproduction apparatus according to the present invention;

FIG. 17 is a diagram showing a structure of a program stored in a terminal apparatus according to the present invention;

FIG. 18 is a diagram showing an example of an EPG executed by a terminal apparatus according to the present invention;

FIG. 19 is a diagram showing an example of an EPG executed by a terminal apparatus according to the present invention;

FIG. 20 is a diagram showing an example of information stored in a secondary storage unit according to the present invention;

FIG. 21 is a diagram showing an example of a record information management table according to the present invention;

FIG. 22 is a schematic diagram showing the details of an AIT specified in the DVB-MHP standard according to the present invention;

FIG. 23 is a schematic diagram showing a file system sent in DSM-CC format according to the present invention;

FIG. 24 is a diagram showing an example of a device connection at the time of recording, in the recording and reproduction apparatus according to the present invention;

FIG. 25 is a diagram showing an example of a device connection at the time of reproduction, in the recording and reproduction apparatus according to the present invention;

FIG. 26 is a diagram showing an example of a record information management table according to the present invention;

FIG. 27 is a diagram showing an example of a configuration of a trick play manager and an AM according to the present invention;

FIG. 28A is a schematic diagram showing details of an AIT for extending the DVB-MHP standard according to the present invention;

FIG. 28B is a schematic diagram showing details of an AIT for extending the DVB-MHP standard according to the present invention;

FIG. 29 is a flowchart at the time of reproducing a service according to the present invention;

FIG. 30 is a flowchart at the time of changing a reproduction speed of a service according to the present invention;

FIG. 31 is a flowchart at the time of updating an AIT according to the present-invention;

FIG. 32 is a diagram showing an example of a configuration of a trick play manager and an AM according to the present invention;

FIG. 33 is a flowchart at the time of updating a paused flag by a Java program according to the present invention;

FIG. 34 is a flowchart at the time of reproducing a service according to the present invention;

FIG. 35 is a diagram showing an example of a configuration of a trick play manager and others according to the present invention;

FIG. 36A is a schematic diagram showing details of an AIT for extending the DVB-MHP standard according to the present invention;

FIG. 36B is a schematic diagram showing details of an AIT for extending the DVB-MHP standard according to the present invention;

FIG. 37 is a flowchart at the time of changing a reproduction speed of a service according to the present invention;

FIG. 38 is a flowchart at the time of updating an AIT according to the present invention;

FIG. 39 is a diagram showing an example of a configuration of a trick play manager and others according to the present invention;

FIG. 40 is a flowchart at the time of updating an invisible flag by a Java program according to the present invention;

FIG. 41 is a schematic diagram showing details of trick play interval processing information according to the present invention, and

FIG. 42 is a schematic diagram showing details of trick play interval processing information according to the present invention.

### DESCRIPTION OF THE PREFERRED EMBODIMENT(S)

The first invention is a recording and reproduction apparatus which records a broadcast wave and reproduces the recorded broadcast wave, the apparatus including: a trick play start/end determination unit which determines a shift from normal reproduction to trick play or a return from trick play to normal reproduction of the recorded broadcast wave; a trick play interval processing management unit which identifies a program which should be shifted to a paused state or a program which should be returned from a paused state, in a trick play interval; and a trick play interval processing unit which makes a request for shifting the program to the paused state or for returning the program from the paused state, wherein the trick play start/end determination unit notifies the trick play interval processing management unit of the shift from the normal reproduction to the trick play or the return from the trick play to the normal reproduction, and the trick play interval processing management unit notifies the trick play interval processing unit of the program which should be shifted to the paused state or the program which should be returned from the paused state.

The second invention is a recording and reproduction apparatus which records a broadcast wave and reproduces the recorded broadcast wave, the apparatus including: a trick play start/end determination unit which determines a shift from normal reproduction to trick play or a return from trick play to normal reproduction of the recorded broadcast wave; a trick play interval processing management unit which identifies a program which should be shifted to an invisible mode or a program which should be returned from an invisible mode, in a trick play interval; and a trick play interval processing unit which makes a request for shifting the program to the invisible mode or for returning the program from the invisible mode, wherein the trick play start/end determination unit notifies the trick play interval processing management unit of the shift from the normal reproduction to the trick play or the return from the trick play to the normal reproduction, and the trick play interval processing management unit notifies the trick play interval processing unit of the program which should be shifted to the invisible mode or the program which should be returned from the invisible mode.

The third invention is a recording and reproduction method of recording a broadcast wave and reproducing the recorded broadcast wave, the method including: a trick play start/end determination step of determining a shift from normal reproduction to trick play or a return from trick play to normal reproduction of the recorded broadcast wave; a trick play interval processing management step of identifying a program which should be shifted to a paused state or a program which should be returned from a paused state, in a trick play interval; and a trick play interval processing step of making a request for shifting the program to the paused state or for returning the program from the paused state, wherein in the trick play start/end determination step, the shift from the normal reproduction to the trick play or the return from the trick play to the normal reproduction is notified for the trick play interval processing management step, and in the trick play interval processing management step, the program which should be shifted to the paused state or the program which should be returned from the paused state is notified for the trick play interval processing step.

The fourth invention is a recording and reproduction method of recording a broadcast wave and reproducing the recorded broadcast wave, the method including: a trick play start/end determination step of determining a shift from normal reproduction to trick play or a return from trick play to normal reproduction of the recorded broadcast wave; a trick play interval processing management step of identifying a program which should be shifted to an invisible mode or a program which should be returned from an invisible mode, in a trick play interval; and a trick play interval processing step of making a request for shifting the program to the invisible mode or for returning the program from the invisible mode, wherein in the trick play start/end determination step, the shift from the normal reproduction to the trick play or the return from the trick play to the normal reproduction is notified for the trick play interval processing management step, and in the trick play interval processing management step, the program which should be shifted to the invisible mode or the program which should be returned from the invisible mode is notified for the trick play interval processing step.

(First Embodiment)

Hereafter, an apparatus and a method according to the first embodiment of the present invention are described with reference to the drawings. The present invention is aimed at recording and reproduction of sent and received contents with an arbitrary medium; however, in the present embodiment, a cable television broadcast system is described as an example. In the cable television broadcast system, the broadcast recording and reproduction apparatus (recording and reproduction apparatus) is generally called a terminal apparatus.

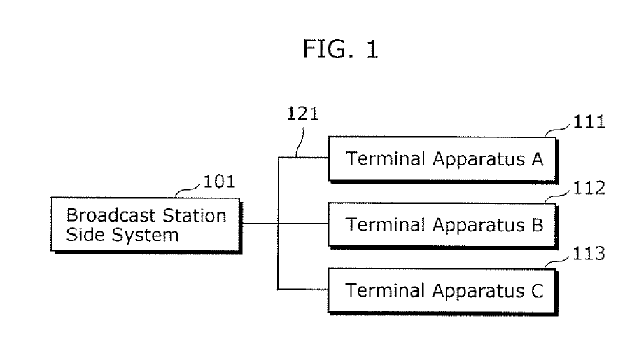

FIG. 1 is a block diagram showing a relationship of apparatuses that make up a broadcast system; the broadcast system is made up of a broadcast station side system 101 (head-end), and three terminal apparatuses: a terminal apparatus A111, a terminal apparatus B112, and a terminal apparatus C113. A coupling 121 between the broadcast station side system and each terminal apparatus is, in the cable system, a wired coupling such as a coaxial cable, a fiber-optic cable, and the like. In FIG. 1, one broadcast station side system is coupled with three terminal apparatuses, but the number of terminal apparatuses is arbitrary.

The broadcast station side system 101 sends information such as video/audio/data for data broadcast in a broadcast signal to a plurality of terminal apparatuses. The broadcast signal is sent using a frequency within a frequency band set by the operational regulations of the broadcast system, the laws of a region/country in which the broadcast system is operated, and so on.

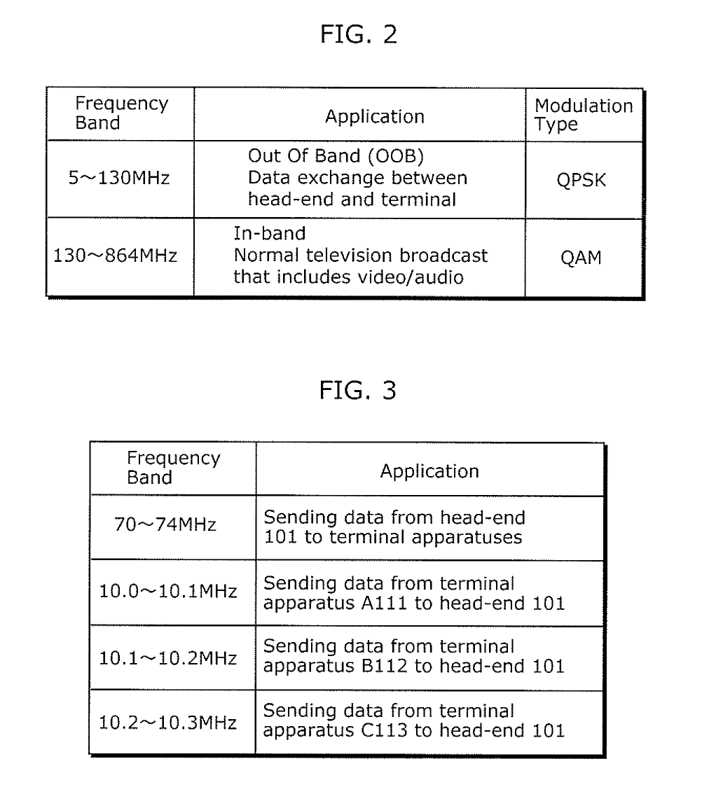

With the cable system in the present embodiment, the frequency band used in broadcast signal transmission is divided for each of data details and transmission directions (inbound, outbound) and assigned thereto. FIG. 2 is a chart indicating one example of the division of the frequency band. The frequency band is roughly divided into two types: Out Of Band (abbr OOB) and In-Band. 5 MHz to 130 MHz is assigned as OOB, and is mainly used in inbound/outbound data exchange between the broadcast station side system 110 and the terminal apparatus A111, the terminal apparatus B112, and the terminal apparatus C113. 130 MHz to 864 MHz is assigned as In-Band, and is mainly used in an outbound-only broadcast channel that includes video/audio. QPSK modulation format is used with OOB, and QAM64 or QAM256 modulation format is used with In-Band. Modulation format technology is generally known and of little concern to the present invention, and therefore detailed descriptions are omitted.

FIG. 3 is one example of a more detailed use of the OOB frequency band. 70 MHz to 74 MHz is used in outbound data sending from the broadcast station side system 101, and all of the terminal apparatus A111, the terminal apparatus B112, and the terminal apparatus C113 receive the same data from the broadcast station side system 101. On the other hand, 10.0 MHz to 10.1 MHz is used in inbound data sending from the terminal apparatus A111 to the broadcast station side system 101; 10.1MHz to 10.2 MHz is used in inbound data sending from the terminal apparatus B112 to the broadcast station side system 101; and 10.2 MHz to 10.3 MHz is used in inbound data sending from the terminal apparatus C113 to the broadcast station side system 101. Through this, it is possible to independently send unique data from each terminal apparatus A111, B112, and C113 to the broadcast station side system 101.

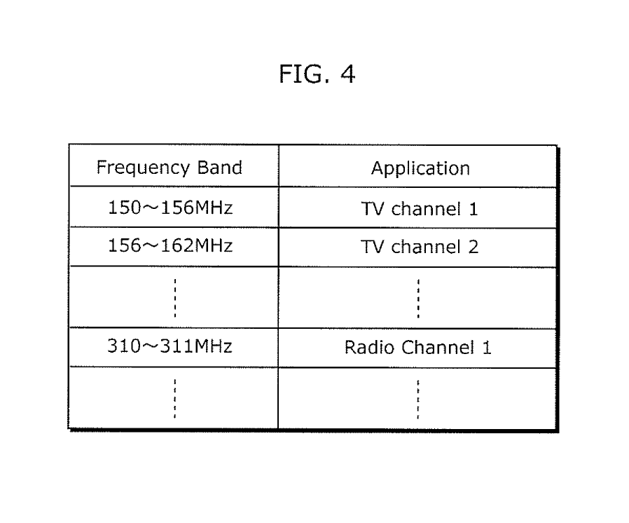

FIG. 4 is one example of use of an In-Band frequency band. 150 MHz to 156 MHz and 156 MHz to 162 MHz are assigned to a TV channel 1 and a TV channel 2 respectively, and thereafter, TV channels are assigned at 6 MHz intervals. Radio channels are assigned in 1 MHz units from 310 MHz on. Each of these channels may be used as analog broadcast or as digital broadcast. Digital broadcast is sent in TS packet format based on MPEG-2 specifications, and it is also possible to send various kinds of data such as data broadcast data and TV show organization information for configuring EPG, in addition to audio and video.

The broadcast station side system 101 uses the frequency bands described above to send an appropriate broadcast signal to the terminal apparatuses, and therefore has a QPSK modulation unit, a QAM modulation unit, and so on. In addition, the broadcast station side system 101 has a QPSK demodulator for receiving data from the terminal apparatuses. Moreover, the broadcast station side system 101 can be thought of as having various devices related to the modulation unit and the demodulation unit. However, the present invention relates mainly to the terminal apparatuses, and therefore detailed descriptions are omitted.

Meanwhile, the terminal apparatuses A111, B112, and C113 each have a QAM demodulation unit and a QPSK demodulation unit in order to receive and reproduce a broadcast signal from the broadcast station side system 101. In addition, each terminal apparatus has a QSPK modulation unit in order to send its unique data to the broadcast station system side 101. In the present invention, the terminal apparatuses are broadcast recording and reproduction apparatuses (recording and reproduction apparatuses), and detailed configurations are described later.

The broadcast station side system 101 modulates an MPEG-2 transport stream and transmits the stream within the broadcast signal. A terminal apparatus receives the broadcast signal, demodulates and reproduces the MPEG-2 transport stream, and extracts necessary information from the stream, and uses it. In order to describe a device function and connection structure present in the terminal apparatus, the structure of the MPEG-2 transport stream is first described in a simple manner.

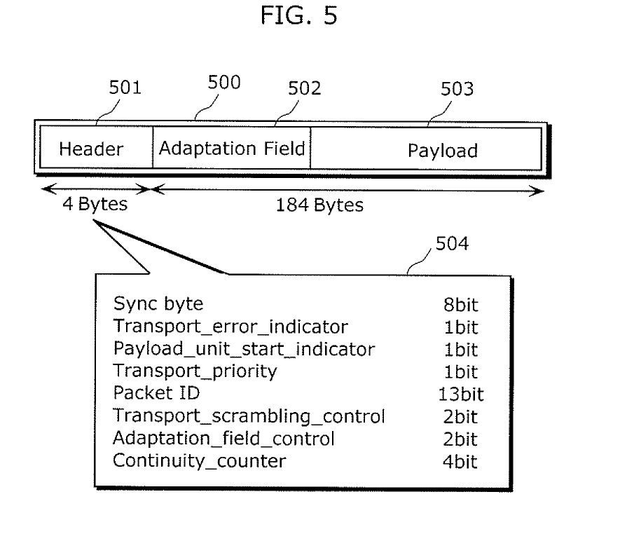

FIG. 5 is a diagram showing the structure of a TS packet. A TS packet 500 has a length of 188 bytes, and is composed of a header 501, an adaptation field 502, and a payload 503. The header 501 holds control information of the TS packet. The header has a length of 4 bytes, and has the structure shown in 504. In the header 501, there is a field denoted as “Packet ID” (hereafter, PID), and the TS packet is identified through the value of this PID. The adaptation field 502 holds additional information such as time information. The adaptation field 502 does not necessarily have to be present, and there are cases where the adaptation field 502 is not present. The payload 503 holds information carried in the TS packets, such as video, audio, and data broadcast data.

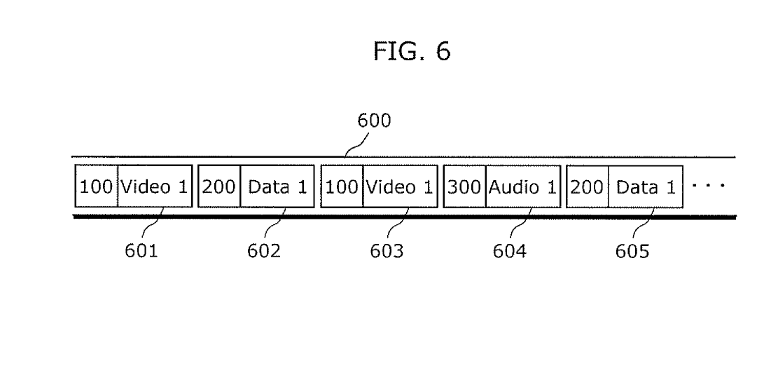

FIG. 6 is a schematic diagram of an MPEG-2 transport stream. The TS packet holds various information in the payload, such as video, audio, data used for data broadcast, and the like. A TS packet 601 and a TS packet 603 each hold a PID 100 in the header, and hold information regarding video I in the payload. A TS packet 602 and a TS packet 605 each hold a PID 200 in the header, and hold information regarding data 1 in the payload. A TS packet 604 holds a PID 300 in the header, and holds information regarding audio 1 in the payload. Mixing TS packets which hold various types of data in the payloads and sending out these packets as a series in sequence is called multiplexing. An MPEG-2 transport stream 600 is one example of a configuration in which the TS packets 601 to 605 are multiplexed.

TS packets that have identical PIDs hold identical types of information. Therefore, the terminal apparatus reproduces video and audio, and reproduces data such as TV show organization information, by receiving multiplexed TS packets and extracting, per PID, the information that the TS packet holds. In FIG. 6, the TS packet 601 and the TS packet 603 each carry information regarding the video 1, and the TS packet 602 and the TS packet 605 each carry information regarding the data 1.

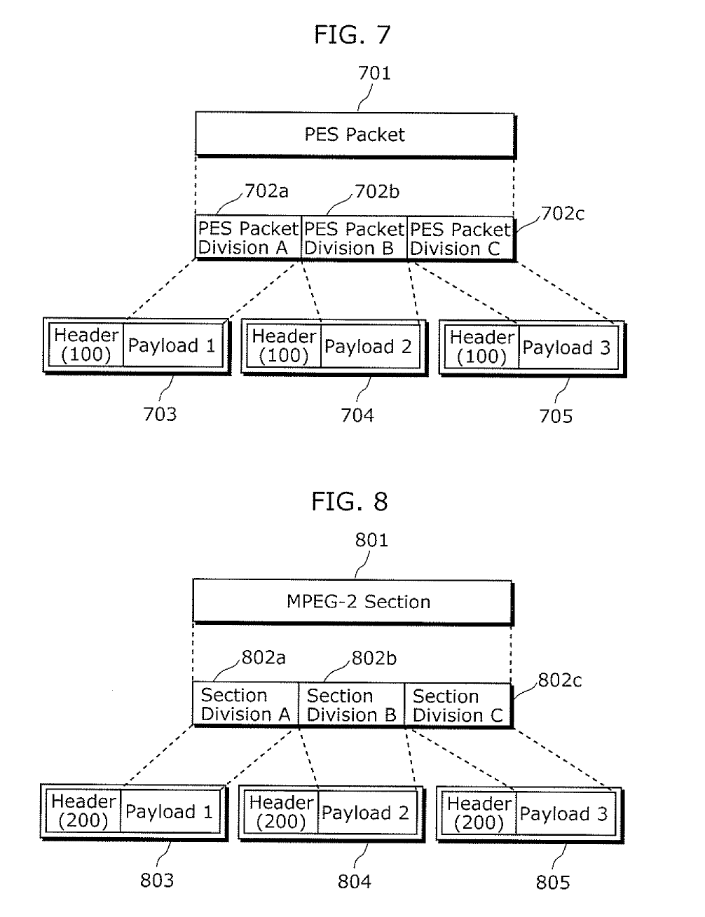

Here, description is given regarding a format of each type of data contained in the payload. Video and audio are represented by a format called a Packetized Elementary Stream (PES) packet. The PES packet includes video information or audio information of certain hours of a day, and by receiving the PES packet, the broadcast recording and reproduction apparatus can output the video and audio information contained in that PES packet to a screen and a speaker. The broadcast station transmits the PES packets without pause, and therefore it is possible for the broadcast recording and reproduction apparatus to continuously reproduce the video and audio without pause. When the PES packet is actually transmitted, the PES packet is divided and stored in the payloads of a plurality of TS packets in the case where the PES packet has a size larger than the payload of one TS packet. FIG. 7 shows an example of division when a PES packet is carried. A PES packet 701 is too large to be stored and transmitted in a payload of a single TS packet, and therefore the PES packet 701 is divided into a PES packet division A 702a, a PES packet division B 702b, and a PES packet division C 702c, and is carried in three TS packets 703 to 705 which have identical PIDS. In actuality, the video and audio are each obtained as an elementary stream (ES) that is obtained by concatenating data contained in the payloads of a plurality of PES packets. The format of this elementary stream is digitalized video and audio, such as defined by the MPEG-2 Video standard, the MPEG-1 and 2 Audio standard, and the like.

On the other hand, information such as the TV show organization information and data used for data broadcast is expressed using a format called MPEG-2 section. When the MPEG-2 section is actually transmitted, the MPEG-2 section is divided and stored in the payloads of a plurality of TS packets in the case where the MPEG-2 section has a size larger than the payload of one TS packet. FIG. 8 shows an example of division when the MPEG-2 section is carried. As an MPEG-2 section 801 is too large to be stored and transmitted in a payload of a single TS packet, the MPEG-2 section 801 is divided into a section division A 802a, a section division B 802b, and a section division C 802c, and is carried in three TS packets 803 to 805 which have identical PIDs.

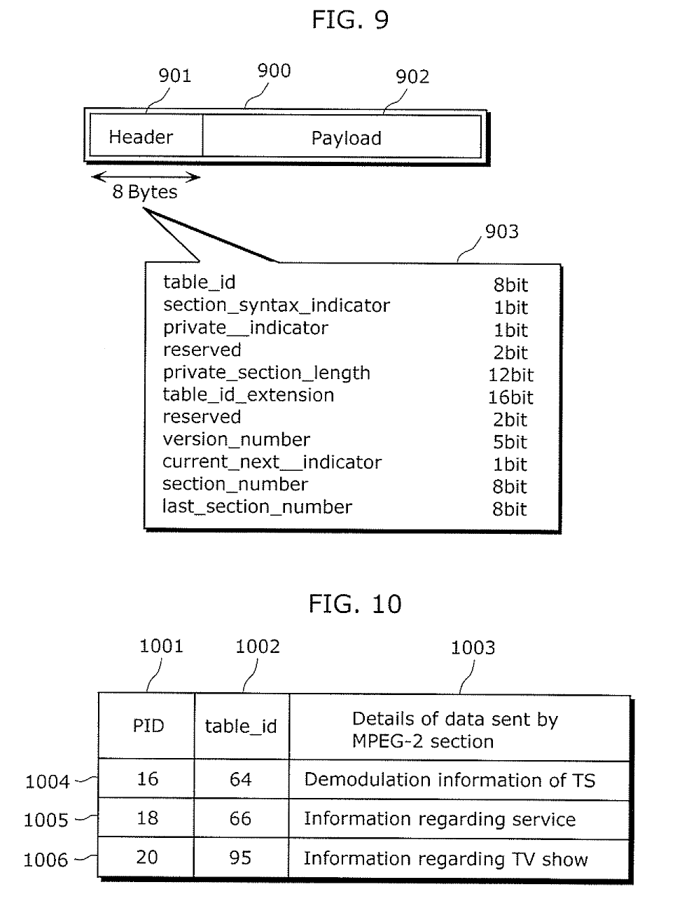

FIG. 9 expresses a structure of the MPEG-2 section. An MPEG-2 section 900 is configured of a header 901 and a payload 902. The header 901 holds control information of the MPEG-2 section. That configuration is expressed by a header configuration 903. The payload 902 holds data carried in the MPEG-2 section 900. A table_id present in the header configuration 903 expresses the type of the MPEG-2 section, and a table_id_extension is an extension identifier used when further distinguishing between MPEG-2 sections with an identical table_id. The case where the TV show organization information is transmitted, as in FIG. 10, can be given as an example of use of the MPEG-2 section. In this example, as denoted in the row 1004, information necessary for demodulating the broadcast signal is denoted in the MPEG-2 section which has a table_id of 64 in the header structure 903, and this MPEG-2 section is further carried in a TS packet assigned with a PID of 16.

The PES format does not exist in the case of the MPEG-2 section. For that reason, the elementary stream (ES) is a concatenation of the payloads of TS packets identified by identical PIDs within the MPEG-2 transport stream. For example, in FIG. 8, the TS packets 803 to 805, in which the MPEG-2 section 801 is divided and carried, all are identified with the PIDs of 200. It can be said that these are the ESs which carry the MPEG-2 section 801.

A concept called a program further exists in the MPEG-2 transport stream. The program is expressed as a collection of ESs, and is used in the case where handling a plurality of ESs all together is desirable. When the program is used, it is possible to handle video/audio, as well as accompanying data broadcast data, all together. For example, in the case of simultaneously handling the video/audio to be reproduced, by grouping the video ES and the audio ES as a program, the broadcast recording and reproduction apparatus should simultaneously reproduce these two ESs as one TV show.

To express the program, two tables, called a Program Map Table (PMT) and a Program Association Table (PAT) are used in MPEG-2. Detailed descriptions can be found in the specifications of ISO/IEC 13818-1, “MPEG-2 Systems”. The PMT and the PAT are described hereafter in simple terms.

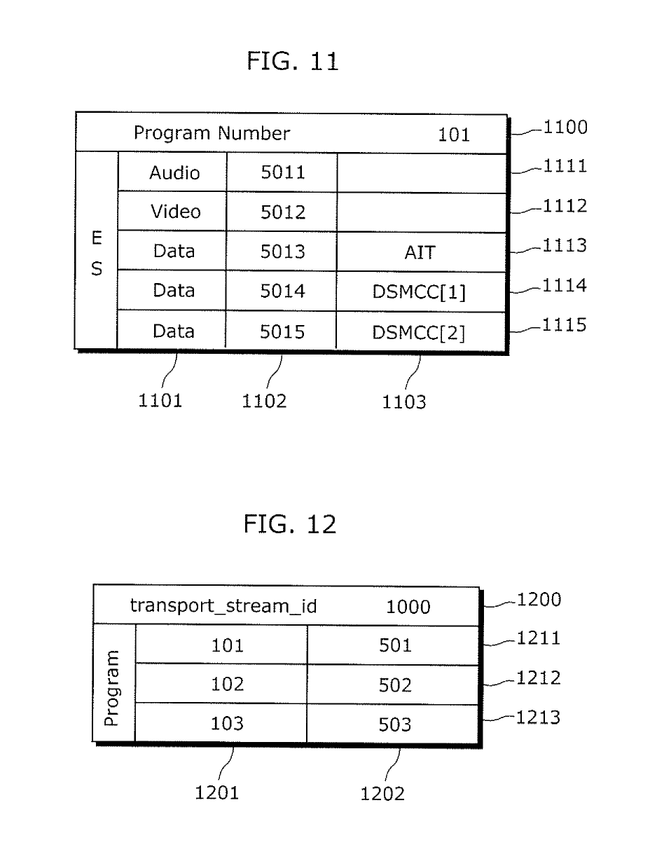

The PMT is a table, as many of which are included in the so MPEG-2 transport stream as the number of programs. The PMT is configured as an MPEG-2 section, and has a table_id of 2. The PMT holds a program number used in identifying the program and additional information of the program, as well as information regarding ESs belonging to the program. An example of the PMT is given in FIG. 11. 1100 shows a program number. The program numbers are assigned uniquely to programs in the same transport stream, and are used in identifying the PMTS. Rows 1111 to 1114 express information regarding individual ESs. A column 1101 shows types of ESs, in which “video”, “audio”, “data”, and so on are specified. A column 1102 shows the PIDs of the TS packets that make up each ES. A column 1103 shows additional information regarding the ESs. For example, the ES shown in the row 1111 is an audio ES, and is carried in a TS packet with a PID of 5011.

The PAT is a table, of which only one is present, in the MPEG-2 transport stream. The PAT is configured as an MPEG-2 section, has a table_id of 0, and is carried in a TS packet with a PID of 0. The PAT holds a transport_stream_id used in identification of the MPEG-2 transport stream, and information regarding all PMTs that represent programs existing in the MPEG-2 transport stream. An example of the PAT is given in FIG. 12. 1200 is a transport_stream_id. The transport stream_id is used in identifying the MPEG-2 transport stream. Rows 1211 to 1213 express information regarding the programs. A column 1201 shows the program numbers. A column 1202 shows the PIDs of the TS packets which carry the PMTs that correspond to respective programs. For example, the PMT of the program shown in the row 1211 has a program number of 101, and the corresponding PMT is carried in the TS packet with a PID of 501.

In the case where the terminal apparatus reproduces a certain program, the terminal apparatus uses the PAT and the PMT and identifies the video and audio that make up the program, and reproduces that video and audio. For example, in regards to the MPEG-2 transport stream that carries the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from a TS packet with a PID of “0”. The PAT is searched to find a program with the program number “101”, and the row 1211 is obtained. From the row 1211, the PID “501”, of the TS packet which carries the PMT of the program with a program number “101”, is obtained. Next, the PMT carried as the MPEG-2 section with a table_id of “2” is acquired from the TS packet with the PID of “501”. A row 1111, which is audio ES information, and a row 1112, which is video ES information, are obtained from the PMT. A PID “5011” of the TS packet which carries the audio ES is obtained from the row 1111. In addition, a PID “5012” of the TS packet which carries the audio ES is obtained from the row 1112. Next, an audio PES packet is acquired from the TS packet with a PID “5011”, and a video PES packet is acquired from the TS packet with a PID of “5012”. Through this, it is possible to obtain the video and audio PES packets to be reproduced, and the video and audio carried in these packets can be reproduced.

Note that there are cases where the MPEG-2 transport stream is scrambled. This is a setup called conditional access system. For example, by scrambling the PES packets which carry certain video and audio, only specified viewers who can descramble them are able to view that video and audio. In order to descramble and view the video and audio, a viewer must descramble them using a device called a descrambler. For example, in an OCAP-compatible terminal apparatus, a card-form adapter with an internal descrambler is used. A cable television operator distributes an adapter set to be able to descramble a specified program to each viewer, and the viewer inserts that adapter into the terminal apparatus. Upon doing so, the adapter descrambles the specified program based on descrambling information such as a descrambling key and contract information of each contract holder A method of descrambling, a method of obtaining a descrambling key, and the like depend on the adapter, and have no influence on the implementation of the present invention.

Thus far, simple descriptions regarding the MPEG-2 specifications have been given, and hereafter, detailed definitions of terminology are given. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program”. Furthermore, concerning the latter, a “program” particularly written in the Java (TM) language is called a “Java program”.

Description has been given regarding several kinds of general information specified in the MPEG-2 specifications according to the present invention. Hereafter, the broadcast recording and reproduction terminal used in the present embodiment is described in detail.

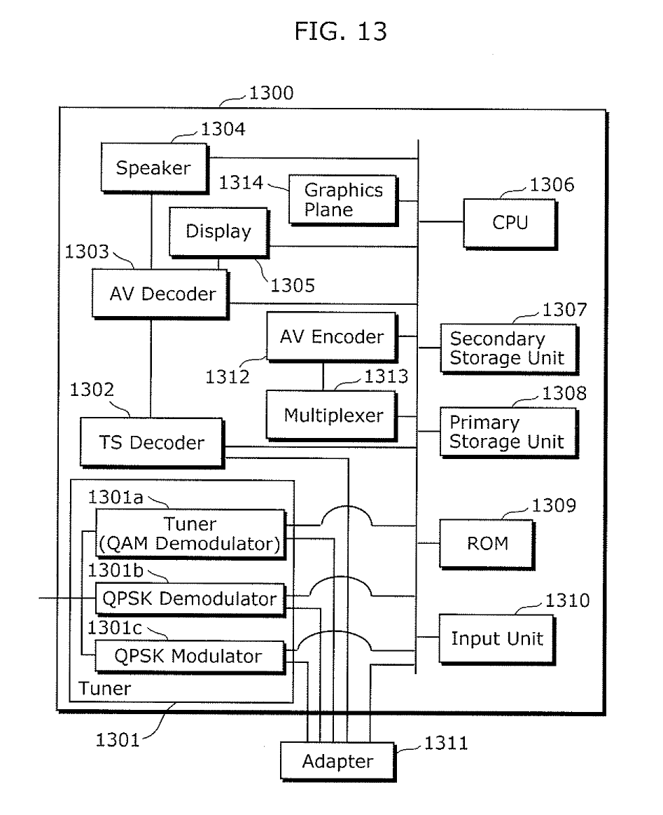

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is a broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313; and a graphics plane 1314. Note that the present embodiment is obtained by expanding a broadcast recording and reproduction terminal realized by the OCAP-DVR specifications, and the basic hardware configuration is nearly identical to that required by the OCAP-DVR specifications.

The tuner 1301 is a device which demodulates a broadcast signal modulated and transmitted from the broadcast station side system 101, in accordance with tuning information such as a frequency and the like specified by the CPU 1306. Here, tuning information is information in which a frequency, a modulation format, and the like can be specified. An MPEG-2 transport stream obtained as a result of demodulation by the tuner 1301 is sent to the TS decoder 1302 via the adapter 1311 with a descrambling function.

The TS decoder 1302 is a device which has a function to segregate PES packets and MPEG-2 sections which comply with specified conditions from the MPEG-2 transport stream, based on a PID, a section filter condition, and so on prescribed by the CPU 1306. In the case where a broadcast is received and a service is reproduced without recording, the MPEG-2 transport stream which the adapter 1311 outputs is inputted to the TS decoder 1302. On the other hand, in the case of reproducing a service recorded in the secondary storage unit 1307, the MPEG-2 transport stream which the secondary storage unit 1307 outputs is inputted to the TS decoder 1302. Which input to receive is controlled by the CPU 1306.

The PES packets of the video and audio which the TS decoder 1302 segregated are outputted to the AV decoder 1303. In addition, the MPEG-2 section segregated by the TS decoder 1302 is transferred to the primary storage unit 1308 through Direct Memory Access (DMA), and is used by a program executed by the CPU 1306.

The AV decoder 1303 is a device with a function to decode the encoded video ES and audio ES. The AV decoder fetches the ES from the PES packet that carries the audio and video information transferred from the TS decoder, and decodes the ES. An audio signal and a video signal obtained through the decoding performed by the AV decoder 1303 are outputted to the speaker 1304 and the display 1305 at the time of service reproduction, but are outputted to the AV encoder 1312 at the time of service recording. Which output route to take is controlled by the CPU 1306, according to an instruction from a user.

The speaker 1304 reproduces audio outputted from the AV decoder 1303.

The display 1305 reproduces video outputted from the AV decoder 1303, and displays graphics on the graphics plane 1314 drawn by the CPU.

The CPU 1306 executes a program that operates in the broadcast recording and reproduction apparatus. The CPU 1306 executes a program contained in the ROM 1309. Or, the CPU 1306 executes a program downloaded from a broadcast signal or a network and held in the primary storage unit 1308. Or, the CPU executes a program downloaded from a broadcast signal or a network and held in the secondary storage unit 1307. The tuner 1301, TS decoder 1302, AV decoder 1303, speaker 1304, display 1305, secondary storage unit 1307, primary storage unit 1308, ROM 1309, input unit 1310, adapter 1311, AV encoder 1312, multiplexer 1313 and graphics plane 1314 are controlled in accordance with the instruction of the executed program. In addition, the CPU 1306 is capable of controlling the adapter 1311 through communication not only with devices present within the terminal apparatus 1300, but with the devices within the adapter 1311.

The secondary storage unit 1307 is a memory apparatus, the memory of which is not deleted even if the power supply to the device is interrupted. The secondary storage unit 1307 is configured of a device where information is not deleted even when the power to the terminal apparatus 1300 is turned off; for example, a nonvolatile memory such as a FLASH-ROM, a Hard Disk Drive (HDD), a rewritable media such as a CD-R and a DVD-R. The secondary storage unit 1307 saves information based on an instruction from the CPU 1306.

The primary storage unit 1308 is a device which has a function for temporarily saving information in accordance with an instruction from the CPU 1306, a DMA transfer-capable device, and so on, and is configured of a RAM or the like.

The ROM 1309 is a non-rewritable memory device, and to be more specific, is configured of a ROM, a CD-ROM, a DVD, and the like. The program which the CPU 1306 executes is stored in the ROM 1309.

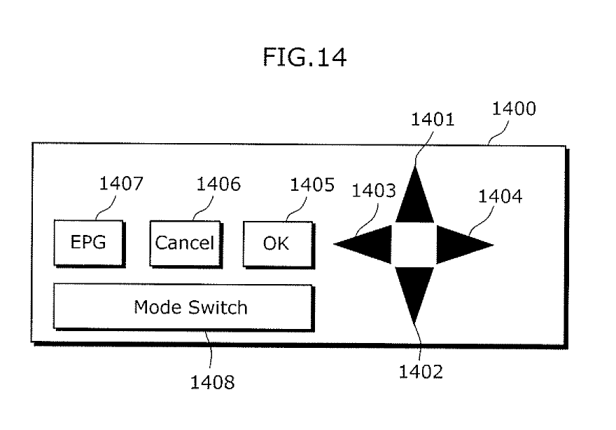

The input unit 1310 is, to be more specific, configured of a front panel or a remote control receiver, and accepts an input from the user. FIG. 14 is one example of the case where the input unit 1310 is configured of the front panel. A front panel 1400 has seven is buttons: an up cursor button 1401, a down cursor button 1402, a left cursor button 1403, a right cursor button 1404, an OK button 1405, a cancel button 1406, an EPG button 1407, and a mode switch button 1408. When the user presses a button, an identifier of the pressed button is notified to the CPU 1306.

The adapter 1311 is a device for descrambling a scrambled MPEG-2 transport stream carried in the In-band frequency range, and includes one or more descramblers. The MPEG-2 transport stream outputted by the tuner 1301a is inputted into the adapter 1311, and descrambling is carried out on the TS packet that has the PID specified by the CPU 1306. The adapter 1311 outputs the descrambled MPEG-2 transport stream to the TS decoder 1302.

Furthermore, the adapter 1311 also carries out format conversion of data sent in an OOB frequency range. Information that is sent in OOB is modulated in the QPSK modulation format. Regarding outbound transmission, the QPSK demodulator 1301b demodulates the outbound signal sent from the broadcast station side system 101, and inputs a generated bit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, regarding inbound transmission, the CPU 1306 inputs information to be sent to the broadcast station side system 101, into the adapter 1311. The adapter 1311 converts the information inputted from the CPU 1306 to a format that can be interpreted by the broadcast station side system 101, and inputs this to the QPSK modulator 1301c. The QPSK modulator 1301c QPSK-modulates the information inputted from the adapter 1311, and sends this to the broadcast station side system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313.

The multiplexer 1313 is a device with a function to multiplex video and audio inputted from the AV encoder 1312, into the MPEG-2 transport stream.

The graphics plane 1314 is a device having a function of temporarily holding graphics drawn by the CPU. Graphics drawn on the graphics plane 1314 are merged with video outputted from the AV decoder 1303 and displayed on the display 1305, in accordance with an instruction from the CPU to transfer the graphics to the display 1305.

An operation in which the broadcast recording and reproduction apparatus described above records a service contained in a broadcast wave into the secondary storage unit 1307, and an operation in which the broadcast recording and reproduction apparatus consecutively reads out the service from the secondary storage unit 1307 and reproduces it, are hereafter described in detail.

First, the operation in which the service contained in the broadcast wave is recorded into the secondary storage unit 1307 is described.

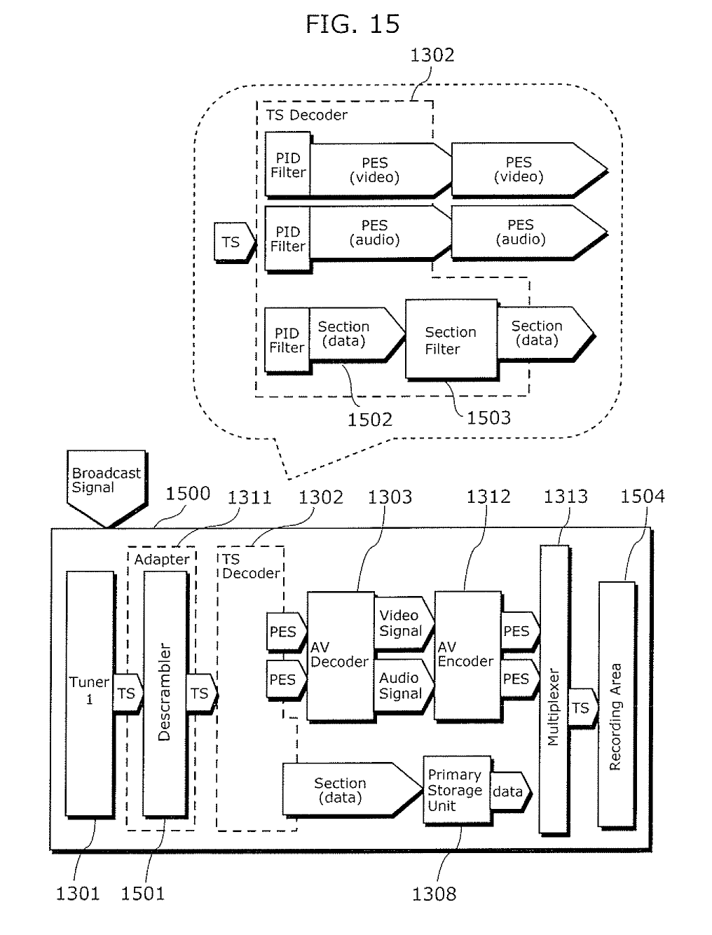

FIG. 15 shows a conceptual diagram which represents the physical connection sequence, processing details, and input/output data format of each device during recording of the service. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504. Constituent elements in FIG. 15 that have the same reference numbers as in FIG. 13 have the same functions and thus description is omitted.

First, the tuner 1301 performs tuning on the broadcast wave in accordance with tuning information specified by the CPU 1306. Here, the tuning information is information in which a frequency, a modulation format, and the like can be specified. The tuner 1301 demodulates the broadcast wave and inputs the MPEG-2 transport stream into the adapter 1311.

The descrambler 1501, which is included in the adapter 1311, descrambles the MPEG-2 transport stream based on conditional access information for each viewer. The descrambled MPEG-2 transport stream is inputted into the TS decoder.

Two types of devices that process the MPEG-2 transport stream are present within the TS decoder 1302: the PID filter 1502 so and the section filter 1503.

The PID filter 1502 extracts, from the inputted MPEG-2 transport stream, a TS packet that has a PID specified by the CPU 1306, and then extracts a PES packet and an MPEG-2 section present in that payload. For example, when the MPEG-2 transport stream in FIG. 6 is inputted in the case where the CPU 1306 has instructed PID filtering which extracts the TS packet with a PID=100, packets 601 and 603 are extracted, then concatenated, and thus a PES packet of a video 1 is reconfigured. Or, when the MPEG-2 transport stream in FIG. 6 is inputted in the case where the CPU 1306 has instructed PID filtering which extracts the TS packet with a PID=200, packets 602 and 605 are extracted, then concatenated, and thus an MPEG-2 section of data 1 is reconfigured.

The section filter 1503 extracts the MPEG-2 section which conforms to a section filter condition specified by the CPU 1306 from among the inputted MPEG-2 sections, and DMA-transfers this MPEG-2 section to the primary storage unit 1308. For example, it is assumed that the CPU 1306 specifies, for the section filter 1503, PID filtering which extracts the TS packet with a PID=200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet so as to convert it into the video, and inputs this into the AV encoder 1312. The AV decoder also decodes the audio PES packet so as to convert it into the audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder into the MPEG-2 section inputted from the primary storage unit 1308, and thus generates an MPEG-2 transport stream. The generated MPEG-2 transport stream is recorded into the recording area 1504.

The recording area 1504 is made up of the whole or a part of the secondary storage unit 1307, or another recording area, and stores the MPEG-2 transport stream that makes up a service.

Next, the operation is described in which the service is consecutively read out from the secondary storage unit 1307 and reproduced.

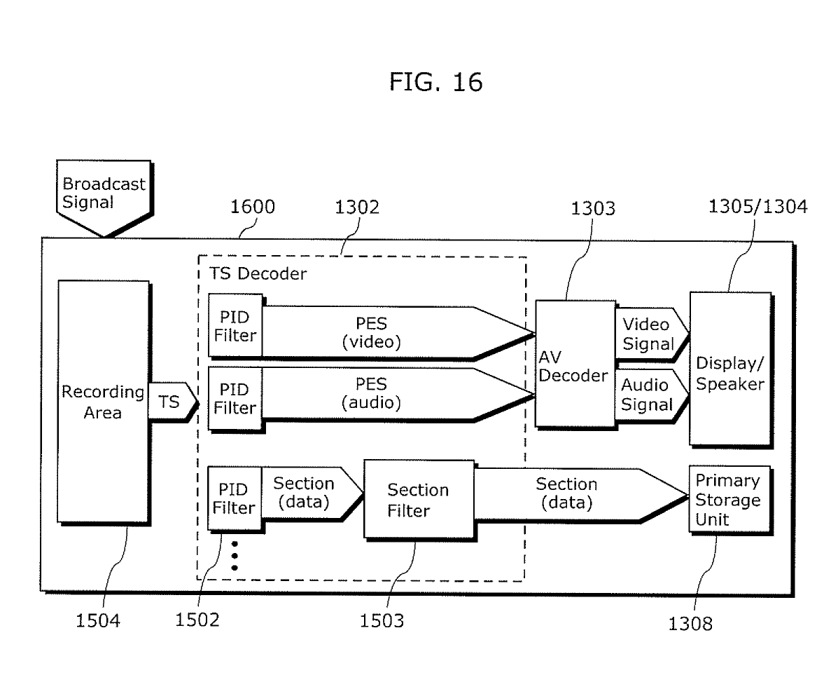

FIG. 16 shows a conceptual diagram which represents the physical connection sequence, processing details, and input/output data format of each device during recording of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same reference numbers as in FIG. 13 have the same functions, and thus description in omitted.

The MPEG-2 transport stream recorded in the recording area 1504 in the procedure described in FIG. 15 is inputted into the TS decoder 1302.

Then, a video PES and an audio PES that have the PIDs specified by the CPU 1306 are extracted by the PID filter 1502 within the TS decoder 1302. The extracted PES packets are inputted into the AV decoder 1303. Or, the MPEG-2 section that has the PID and table_id specified by the CPU 1306 is extracted by the PID filter 1502 and the section filter 1503 within the TS decoder 1302. The extracted MPEG-2 section is DMA-transferred to the primary storage unit 1308.

The video PES and the audio PES inputted into the AV decoder 1303 are decoded and outputted as an audio signal and a video signal. After that, the audio signal and the video signal are inputted into the display 1305 and the speaker 1304, thus reproducing the audio and the video.

The MPEG-2 section inputted into the primary storage unit 1308 is inputted into the CPU 1306 as appropriate.

Thus far, an example of a hardware configuration regarding the present invention has been described. Hereafter, a main function of the present invention, which is control of recording and control of trick play of a service via a Java program, is described.

Recording of the service in the present invention refers to recording video, audio, a Java program, synchronization information of the Java program, and so on that are contained in the service, into a recording medium such as a hard disk, a Blu-ray Disc (BD), a Digital Versatile Disc (DVD), and a Secure Digital (SD) memory card. Reproduction of the service refers to reproduction and execution of the video, audio and Java program recorded in the recording medium, based on the synchronization information. A reproduction result of a recorded service is required to be almost equivalent to a result of directly reproducing the service upon receiving a broadcast wave.

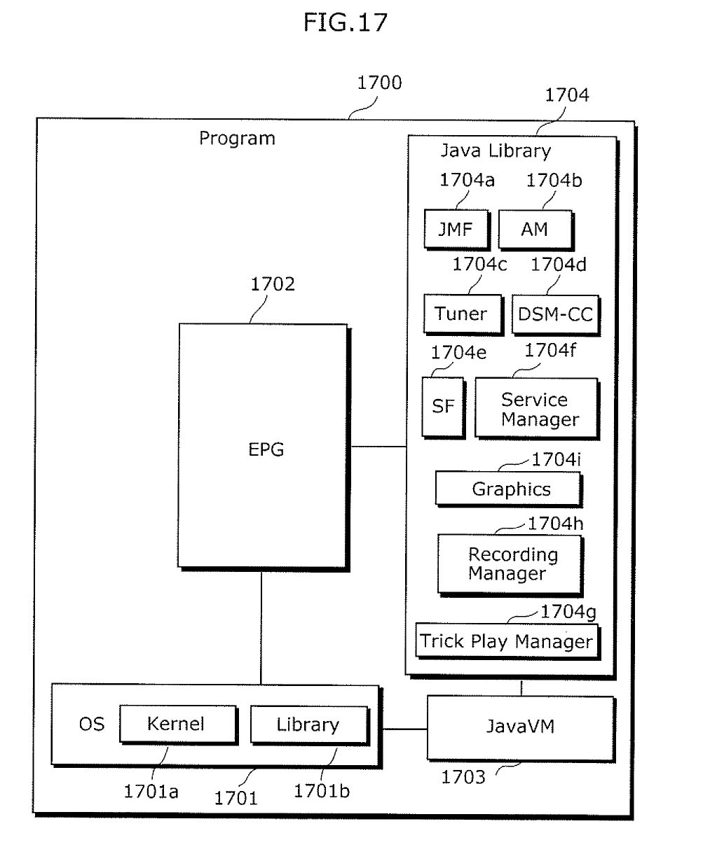

FIG. 17 is a configuration diagram of a program necessary for recording and reproduction of the service, and is software recorded into the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of: a kernel 1701a so for executing other sub-programs such as the EPG 1702 and the Java VM 1703; and a library 1701b which the sub-programs use to control the constituent elements of the terminal apparatus 1300. The kernel 1701a is publicly-known technology and therefore detailed description is omitted.

The library 1701b provides, for example, a tuning function for controlling the tuner. The library 1701b receives, from another sub-program, tuning information in which a frequency, modulation format and the like can be specified, and supplies this to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

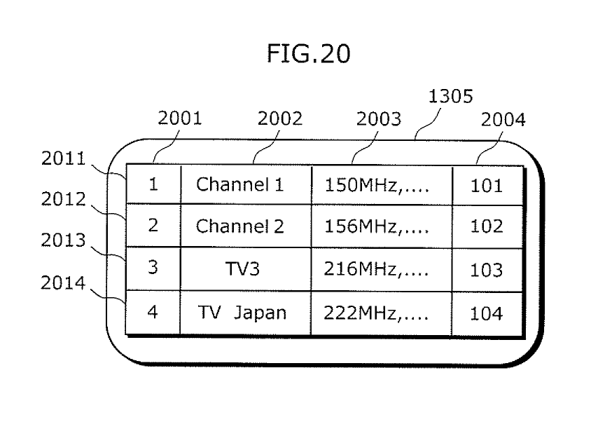

Also, the library 1701b provides channel information for uniquely identifying a channel, An example of the channel information is shown in FIG. 20. The channel information is sent using an OOB or an In-band frequency range, is converted into a chart format by the adapter 1311, and is stored in a temporary memory unit which can be accessed by the library. A column 2001 shows channel identifiers, and is equivalent to, for example, source_IDs as defined by SCTE65 Service Information Delivered Out-Of-Band For Digital Cable Television. A column 2002 shows channel names, and is equivalent to source_name and the like, from the same SCTE65 standard. A column 2003 is tuning information, and is information in which a frequency, a transfer rate, a modulation format, and the like can be specified, that is given to the tuner 1301. A column 2004 shows program numbers for identifying the PMTs. For example, a row 2011 is a group of service information including a channel identifier of “1”, a channel name of “channel 1”, a frequency of “150 MHz, . . .” in the tuning information, and a program number of “101”.

The JavaVM 1703 is a lava virtual machine that sequentially analyzes and executes programs written in the Java (TM) language. Programs written in the Java language are compiled of intermediate code which does not depend on the hardware, called bytecode. The Java virtual machine is an interpreter which executes this bytecode. The Java VM 1703 executes the Java library 1704 that is written in the Java language. Details of the Java language and Java VM are explained in publications such as “Java Language Specification” (ISBN 0-201-63451-1) and “Java Virtual Machine Specification” (ISBN 0-201-63451-X), and so on. In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by the Java program in order to control functions of the broadcast recording and reproduction apparatus. However, there are situations where a sub-program written in non-Java language, such as the library 1701b of the OS 1701, is used as necessary. The Java program can use a function provided by the Java library 1704 by calling a Java Application Programming Interface (API) held by the Java library 1704.

A Tuner 1704c is a Java library for controlling the In-band receiving tuner 1301a in the broadcast recording and reproduction terminal. When the Java program passes tuning information to the tuner 1704c, the tuner 1704c uses that information to call a tuning function of the library 1701b, and as a result, it is possible to control an operation of the In-band receiving tuner 1301a of the broadcast recording and reproduction terminal. Here, tuning information is information in which a frequency, a modulation format, and the like can be specified.

An SF 1704e is a Java library for controlling a function of the PID filter 1502 and the section filter 1503 of the broadcast recording and reproduction terminal. When the Java program passes filter conditions such as a PID, table_id, and the like to the SF 1704e, the SF 1704e uses a function of the library 1701b and the like based on those conditions, so as to control the PID filter 1502 and the section filter 1503, acquires an MPEG-2 section that fulfills desired filter conditions, and passes the MPEG-2 section to the Java program that set the filter conditions.

A DSM-CC 1704d is a Java library for accessing a file system of a DSM-CC object carousel. The DSM-CC object carousel is included in the MPEG-2 section acquired by the SF 1704e. The DSM-CC is defined by the ISO/IEC 13818-6 standard, and is a mechanism for using the MPEG-2 section so as to carry an arbitrary file. By using this, it is possible to send a file from a broadcast station to a terminal. Based on a file identifier and the like specified by the Java program and so on, the DSM-CC 1704d uses the SF 1704e and acquires the MPEG-2 section, fetches a file based on the ISO/IEC 13818-6 standard, and outputs this file to the primary storage unit 1308. A detailed method for implementing the DSM-CC is of no relation to the present invention, and therefore details are omitted.

An AM 1704b is an application program manager that provides a function for managing the execution and termination of the Java program contained in the service. The AM 1704b extracts a Java program multiplexed into a specified channel of a specified MPEG-2 transport stream, and causes the execution or termination of that extracted Java program in accordance with separately-multiplexed synchronization information. A Java class file of the Java program is multiplexed into the MPEG-2 transport stream in the aforementioned DSM-CC format. In addition, the synchronization information of the Java program is multiplexed into the MPEG-2 transport stream in a format called AIT. AIT is an acronym of Application Information Table, as defined in Section 10 of the DVB-MHP specification (ETSITS 101812 DVB-MHP specification V1.0.2, and is an MPEG-2 section with a table_id of “0x74”.

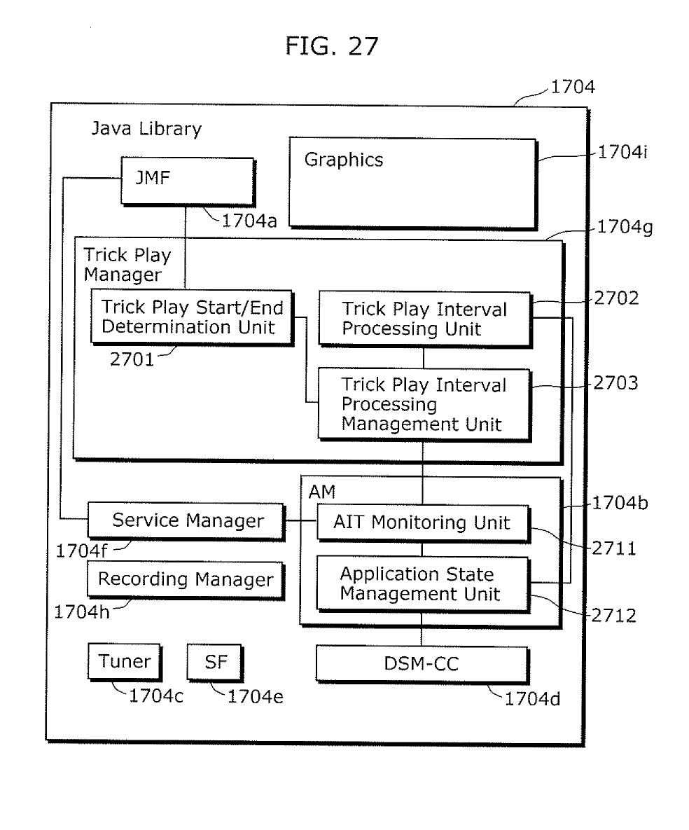

A detailed configuration of the AM 1704b is shown in FIG. 27. The AM 1704b is configured of an AIT monitoring unit 2711 and an application state managing unit 2712.

The AIT monitoring unit 2711 monitors the AIT update state receiving an MPEG-2 transport stream and a channel identifier as input, and if the AIT is updated, notifies the application state management unit 2712 and the trick play interval processing management unit 2703 of the updated AIT. First, the JMF 1704b searches for channel information in the library 1701b using a specified channel identifier as a key, and finds the program number. Next, using the SF 1704e and,the like, a PAT is acquired from the MPEG-2 transport stream. Then, the PID of a PMT that corresponds to the obtained program number is obtained from information of the PMT. Once again, using the SF 1704e, the actual PMT is acquired. The acquired PMT is in a format as shown in FIG. 11, and has written the PID of an elementary stream that has “data” as a stream type and “AIT” as supplemental information. Furthermore, when the PID and table_id “0x74” of the AIT now obtained as the filter conditions are given to the SF 1701e, the actual AIT is obtained.

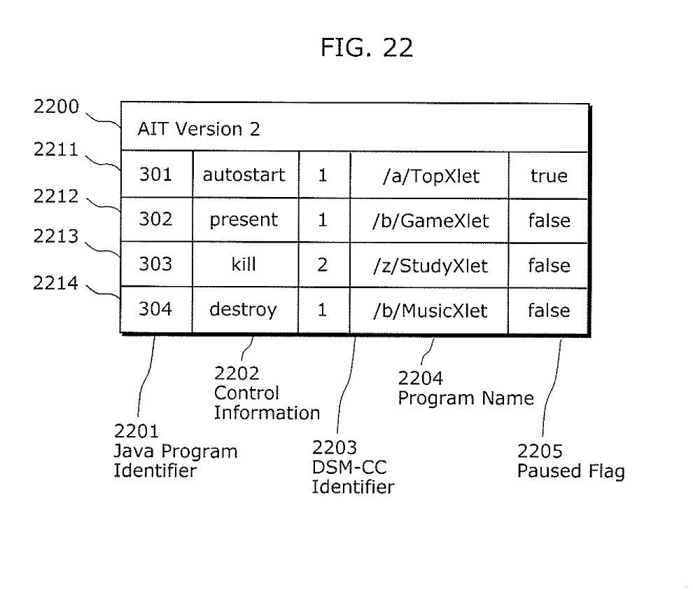

FIG. 22 is a chart that schematically shows an example of the AIT information. An AIT version number 2200 expresses the version of that AIT. The higher the version of the AIT is, the newer the AIT is. An AIT of the same AIT version is repeatedly received, but the AM 1704b does not analyze an AIT with the same AIT version as an AIT that has already been analyzed, but analyzes only an AIT that is newer than the already-analyzed AIT and performs the corresponding processing. A column 2201 shows identifiers of the Java programs. A column 2202 shows control information of the Java programs. As the control information, there are “autostart”, “present”, “kill”, and the like; “autostart” means that the terminal apparatus 1300 executes the Java program automatically in an instant, “present” means not performing automatic execution, and “kill” means stopping the Java program. A column 2203 is a DSM-CC identifier for extracting the PID that includes the Java program in the DSM-CC format. A column 2204 is a program name of the Java program.

A column 2205 is a paused flag that corresponds to each Java program. The paused flag is a flag that indicates whether or not the corresponding Java program is to be paused during trick play. The value “true” of the paused flag means that the corresponding Java program is paused in a trick play mode, and then, when the trick play mode is canceled to return to a normal reproduction mode, the execution of the paused. Java program is resumed. The value “false” of the paused flag means that the corresponding Java program is continued to be executed without being paused even in a trick play mode. In FIG. 22, as a Java program “/a/TopXlet” corresponding to a Java program identifier “301” has its paused flag value of “true”, the Java program is paused during trick play.

Rows 2211, 2212, 2213, and 2214 are a group of the information of the Java programs. The Java program defined in the row 2211 is a group including a Java program identifier “301”, control information “autostart”, a DSM-CC identifier “1”, a program name “a/TopXlet”, and a paused flag “true”. Similarly, the Java program defined in the row 2212 is a group including a Java program identifier “302”, control information “present”, a DSM-CC identifier “1”, a program name “b/GameXlet”, and a paused flag “false”. Here, the three Java programs defined in the rows 2211, 2212, and 2214 have the same DSM-CC identifiers. This indicates that the three Java programs are included in one file system encoded in the DSM-CC format. Here, five types of information are prescribed for each Java program, but in reality, more types of information are defined. Details can be found in the DVB-MHP specification.

The application state management unit 2712 manages the Java program execution state by accepting a request from the trick play interval processing unit 2702 or by analyzing the details of the updated AIT passed from the AIT monitoring unit 2711.

First, the operation of the application state management unit 2712 when the AIT is passed from the AIT monitoring unit 2711 is described hereinafter.

The application state management unit 2712 finds out a Java program with “autostart” within the AIT, and extracts the corresponding DSM-CC identifier and Java program name. Referring to FIG. 22, the application state management unit 2712 extracts the Java program from the row 2211 and acquires the DSM-CC identifier of “1” and the Java program name of “a/TopXlet.” Next, the application state management unit 2712 uses the DSM-CC identifier acquired from the AIT so as to acquire, from the PMT, the PID of the TS packet storing the Java program in the DSM-CC format. Specifically, the PID of the elementary stream with a conforming DSM-CC identifier in the supplementary information and which has a stream type of “data” is acquired from the PMT. Assuming here that the DSM-CC identifier is “1” and the PMT is as in FIG. 11, the elementary stream of the row 1114 conforms to the above elementary stream, and the PID “5014” is fetched.

The application state management unit 2712 specifies, to the SF 1704e, the section filter conditions and the PID of the TS packet which carries the MPEG-2 section embedded with data in the DSM-CC format. Here, the PID “5014” is given. As a result, the application state management unit 2712 reconstitutes the file system using the DSM-CC 1704d in accordance with the DSM-CC format, and saves the file system into the primary storage unit 1308. Fetching data such as a file system from a TS packet in an MPEG-2 transport stream and saving the data into a storage means such as the primary storage unit 1308 and the secondary storage unit 1307 is hereafter called downloading.

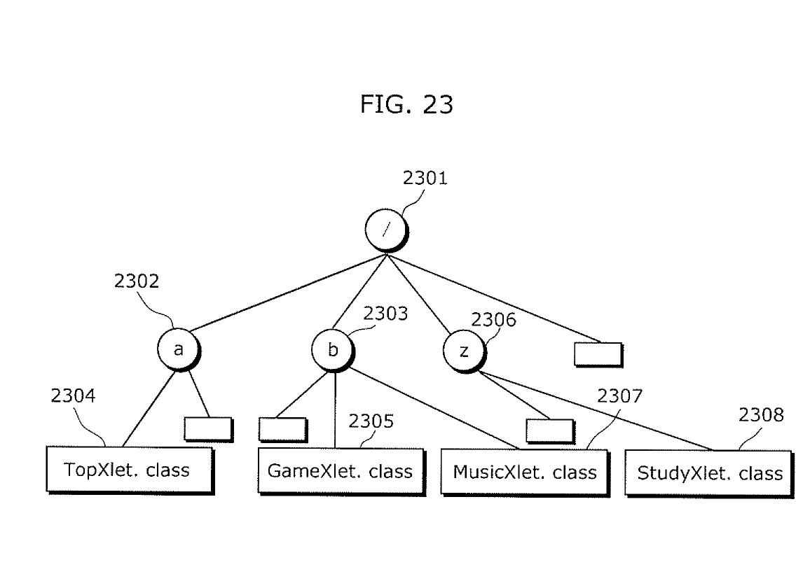

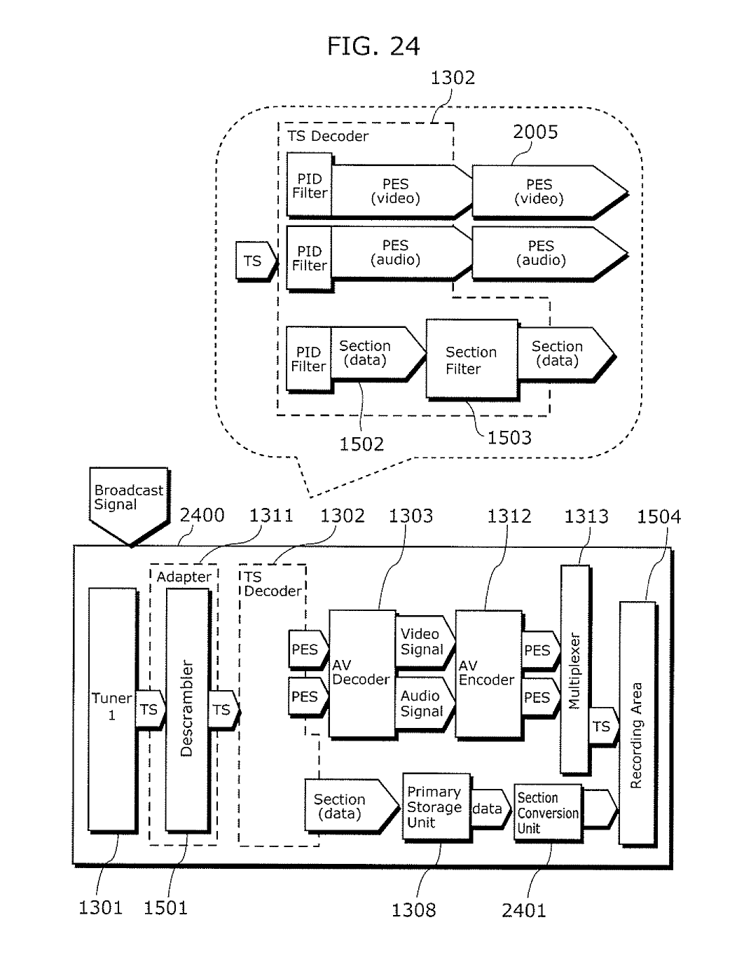

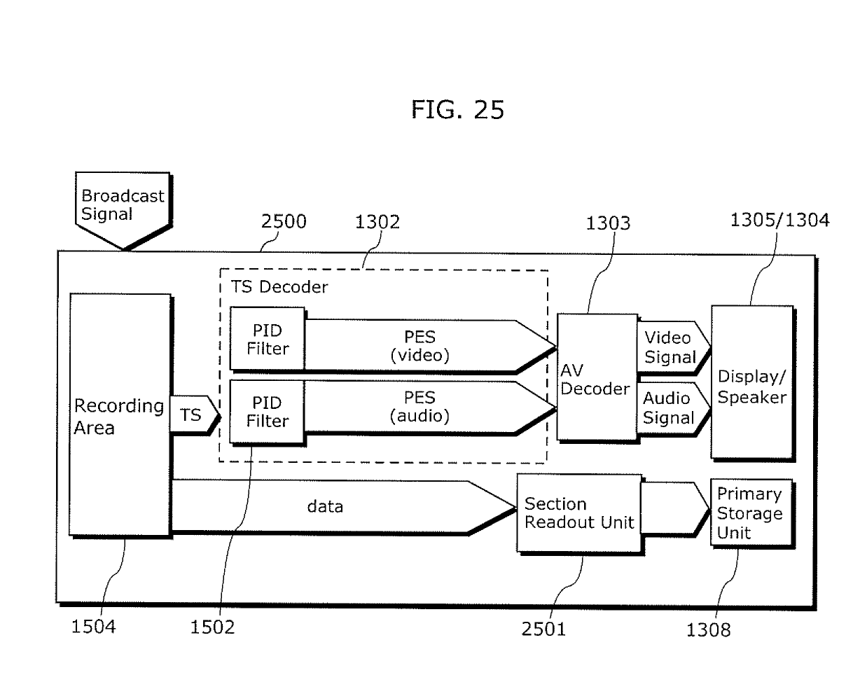

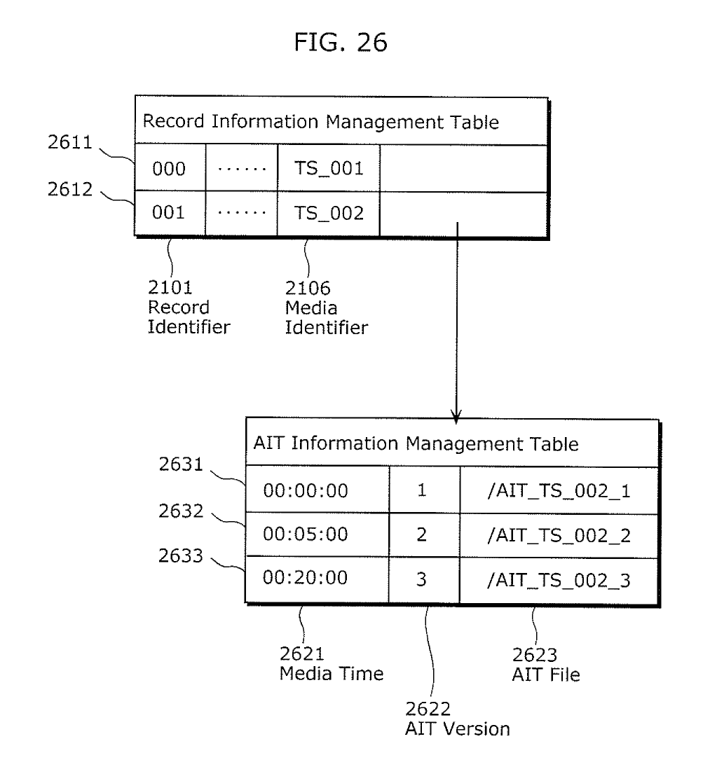

FIG. 23 is an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file a “MusicXlet.class”, and 2308 is a file “StudyXlet.class”.

Next, the application state managing unit 2712 passes the Java program to be executed to the Java VM 1703, from among the file systems downloaded to the primary storage unit 1308. Here, when the name of the Java program to be executed is “a/TopXlet”, the file “a/TopXlet.class”, in which “.class” is added to the end of the Java program name, is the file to be executed. “/” is a directory and file name division, and referring to FIG. 23, the file 2304 is the Java program which should be executed. Next, the application state management unit 2712 passes the file 2304 to the Java VM 1703, and the file is executed, as a Java program, on the Java VM. In the case where the control information of “kill” is specified, the Java program is terminated.

Every time receiving an AIT with a new AIT version, the application state management unit 2712 analyzes the AIT and changes the execution state of the Java program.

Next, the operation of the application state management unit 2712 when it is requested by the trick play interval processing unit 2702 to change the state of a Java program is described hereinafter.

The application state management unit 2712 provides, as a function of managing the Java program execution state, a function of pausing a Java program corresponding to a specified Java program identifier, and a function of resuming the paused Java program. More specifically, the application state management unit 2712 provides a method “pause(int appID)” for pausing a Java program, and a method “resume(int appID)” for executing the paused Java program again. Here, appID is a Java program identifier. When the trick play interval processing unit 2702 calls the pause method, the application state management unit 2712 pauses a lava program corresponding to a Java program identifier specified as an argument. For example, if pause (503) is called, the application state management unit 2712 pauses a Java program corresponding to a Java program identifier of “503”. When the trick play interval processing unit 2702 calls the resume method, the application state management unit 2712 resumes a Java program corresponding to a Java program identifier specified as an argument. For example, if resume (503) is called, the application state management unit 2712 resumes a Java program corresponding to a Java program identifier of “503”.

The JMF 1704a handles control of reproduction of the video and audio contained in the service. To be more specific, the JIMF 1704a inputs the video ES and audio ES multiplexed into the specified channel of the specified MPEG-2 transport stream, into the AV decoder for reproduction. In the case where the service is reproduced directly from the received broadcast wave, it is instructed to reproduce the MPEG-2 transport stream outputted from the adapter 1311. On the other hand, in the case where the service which has been stored once in the secondary storage unit 1307 is reproduced, it is instructed to reproduce the MPEG-2 transport stream outputted from the recording area 1504 in the secondary storage unit 1307.

First, the JMF 1704a searches for channel information in the library 1701b with a specified channel identifier as a key, and acquires the program number. Next, using the SF 1704e and the like, a PAT is acquired from the MPEG-2 transport stream. Then, the PID of the PMT that corresponds to the acquired program number is obtained from the information of the PMT. Once again, using the SF 1704e, the actual PMT is acquired. The acquired PMT is in a format as shown in FIG. 11, and has written the PIDs of elementary streams that have “video” and “audio” as the stream types. When the JMF 1704a sets these PIDs to the PID filter 1502 of the TS decoder 1302, the video ES and audio ES multiplexed with these PIDs are reproduced through the AV decoder 1303, as shown in FIG. 15 or FIG. 16.

Here, in the case where the JMF 1704a receives, as an input, an MPEG-2 transport stream which has already been recorded in the secondary storage unit, the JMF 1704a can change the reproduction speed of video and audio by changing the reading speed and reading position of the MPEG-2 transport stream from a storage area 1607 of the secondary storage unit 1307. Thus, trick play such as fast-forward and skip becomes possible. For example, if an MPEG-2 transport stream is read out at the double speed of the normal speed, video and audio are also reproduced at the double speed. In addition, if an MPEG-2 transport stream is read out while skipping is only a specific interval of time, video and audio are reproduced while skipping it. By using the function of the library 1701b, the JMF 1704a controls the secondary storage unit 1307 and changes the reading speed and reading position in an MPEG-2 transport stream.

Since the method for performing such trick play smoothly and in a high level is out of the scope of the present invention, the description thereof is omitted.

In order for a Java program to instruct trick play, the MF 1704a provides an API such as setrate (float factor) to the Java program. When 1.0 is set for a parameter factor, normal speed reproduction is performed, and when 2.0 is set, trick play at the double speed is performed. Furthermore, in the case where a Java program instructs trick play through an API, the JMF 1704a passes the reproduction speed before the instruction of the trick play and the reproduction speed after that instruction to the trick play start/end determination unit 2701 of the trick play manager 1704g.

Having a channel identifier, start time, and end time as inputs, the recording manager 1704h records the service into the secondary storage unit 1307, only for the period of time between the specified start time and end time of the service. For example, if the EPG 1702 specifies the channel identifier, start time, and end time, the recording manager 1704h stands by until the start time. After that, it starts recording the specified service when the start time is reached, and it stops recording when the end time is reached. Details are described below.

At the recording start time, the recording manager 1704h first secures, within the secondary storage unit 1307, a recording area 1504 for recording the MPEG-2 transport stream from the start time to the end time specified in the secondary storage unit 1307. A media identifier is supplied to the secured recording area. Next, with the channel identifier as a key, the recording manager 1704h obtains tuning information that corresponds to the channel identifier from channel information held by the library 1701b. After that, when the recording manager 1704h supplies the tuning information to the Tuner 1704c, the Tuner 1704c commences tuning. Here, the tuning information is information in which a frequency, a modulation format, and the like that can be specified. Then, as shown in FIG. 15, the MPEG-2 transport stream is inputted into the TS decoder via the adapter 1311.

Meanwhile, using the SF 1704e, the recording manager 1704h acquires the PAT from the MPEG-2 transport stream obtained through the tuning. Furthermore, it searches the library 1701b to find out the program number corresponding to the specified channel identifier, and searches the PAT to find out the PID of the PMT corresponding to the obtained program number. After that, using the SF 1704e, it acquires the actual PMT so as to obtain all the PIDs of the ESs which make up the specified channel. The recording manager 1704h sets the obtained PIDs to the PID filter 1502 of the TS decoder. Furthermore, an output destination of each hardware constituent element is set through the library 1701b so as to follow the operation of recording the service included in the broadcast wave into the secondary storage unit 1307. Then, in accordance with the flow explained in FIG. 15, all ESs that make up a desired channel are recorded into the recording area 1504 that has been a secured.

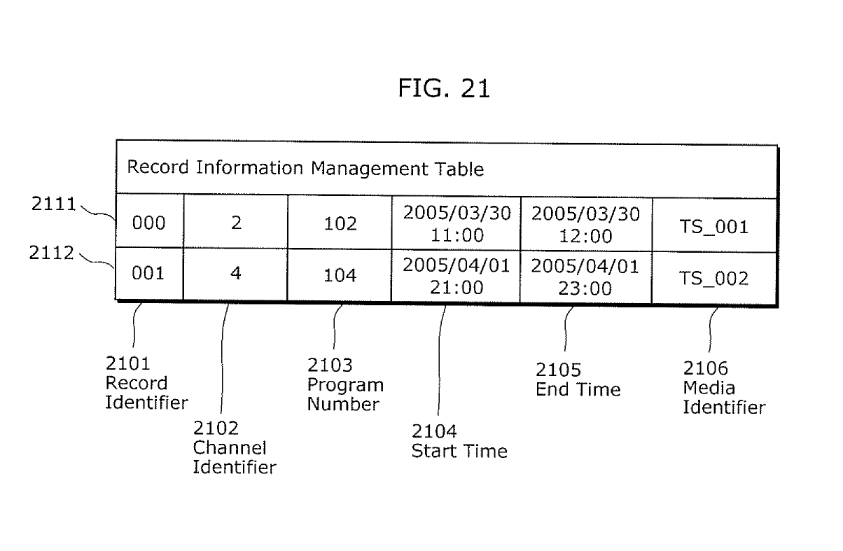

After that, when the specified end time is reached, the recording manager 1704h stops the tuning operation of the Tuner 1704c, and causes the writing of the MPEG-2 transport stream into the recording area 1504 to end. In addition, a record information management table as shown in FIG. 21 is created as management information of the MPEG-2 transport stream which has been recorded earlier.

FIG. 21 is an example of the record information management table for managing the record information recorded into the recording area 1504 of the secondary storage unit 1307 and the like. The record information is recorded in chart format. A column 2101 shows record identifiers. A column 2102 shows channel identifiers. A column 2103 shows program numbers. A column 2104 shows record start times for respective services, and a column 2105 shows record end times for the services. A column 2106 shows media identifiers that identify the MPEG-2 transport streams that are recorded as services. Each of the rows 2111 to 2112 is a group of each record identifier, channel identifier, program number, start time, end time, and media identifier. For example, the row 2111 shows a record identifier of “000”, a channel identifier of “2”, a program number of “102”, a start time of “2005/03/30 11:00”, an end time of “2005/03/30 12:00”, and a media identifier of “TS_{—}001”.

The service manager 1704f manages reproduction of the service within the MPEG-2 transport stream that has been recorded into the secondary storage unit 1307, or the service within the MPEG-2 transport stream inputted from the adapter 1311.

Hereafter, an operation in the case of managing reproduction of the service contained within the MPEG-2 transport stream which has been recorded in the secondary storage unit 1307 is described. This is equivalent to reproduction of an already-recorded service. In this case, the service manager 1704f has the record identifier as an input. The service already recorded in the secondary storage unit 1307 and identified by that record identifier is to be reproduced.

First, referring to the record information management table created by the recording manager 1704h, the service manager 1704f obtains the channel identifier and the media identifier of the service to be reproduced, with the specified record identifier. Then, through the library 1701b, the service manager 1704f instructs the secondary storage unit 1307 to output, to the TS decoder 1302, the MPEG-2 transport stream identified by the obtained media identifier. In addition, through the library 1701b, the service manager 1704f sets the output destination of each hardware constituent element to flow through the path shown in FIG. 16. After that, the secondary storage unit 1307 is provided to the 3MF 1704a as the location of the MPEG-2 transport stream, and the channel identifier of the service to be reproduced is provided. Then, through the operation described above, the JMF 1704a starts reproduction of the audio and video multiplexed into the MPEG-2 transport stream outputted from the secondary storage unit 1307.

After that, the secondary storage unit 1307 is also provided to the AM 1704b as the location of the MPEG-2 transport stream, and the channel identifier of the service to be reproduced is provided. Then, in accordance with the AIT multiplexed into the MPEG-2 transport stream outputted from the secondary storage unit 1307, the AM 1704b starts execution and termination of the Java program multiplexed into the MPEG-2 transport stream outputted from the secondary storage unit 1307. After that, reproduction of the above-mentioned service is continued until the end of the MPEG-2 transport stream outputted from the secondary storage unit 1307,

On the other hand, the case of managing reproduction of the service within the MPEG-2 transport stream inputted from the adapter 1311 is described hereafter. This is equivalent to reproducing the service directly from the broadcast wave. In this case, the service manager 1704f has the channel identifier of the service to be reproduced as an input.

Through the library 1701, the service manager 1704f instructs the MPEG-2 transport stream outputted from the adapter 1311 of FIG. 15 to be outputted to the TS decoder 1302. In addition, through the library 1701b, the service manager 1704f sets the output destination of each hardware constituent element to flow through the path shown in FIG. 16. First, with the channel identifier as a key, the service manager 1704f obtains tuning information that corresponds to the channel identifier from channel information held by the library 1701b. After that, when the tuning information is given to the Tuner 1704c, the Tuner 1704c commences tuning. Here, the tuning information is information in which a frequency, a modulation format, and the like can be specified. After that, the adapter 1311 is provided to the JMF 1704a as the location of the MPEG-2 transport stream, and the channel identifier of the service to be reproduced is provided. Then, through the operation described above, the JMF 1704a starts reproduction of the audio and video multiplexed into the MPEG-2 transport stream outputted from the adapter 1311.

Furthermore, the adapter 1311 is also provided to the AM 1704b as the location of the MPEG-2 transport stream, and the channel identifier of the service to be reproduced is provided. Then, in accordance with the AIT multiplexed into the MPEG-2 transport stream outputted from the adapter 1311, the AM 1704b commences execution and termination of the Java program multiplexed into the MPEG-2 transport stream outputted from the secondary storage unit 1307. After that, reproduction of the service is continued until the end of the MPEG-2 transport stream outputted from the secondary storage unit 1307.

The graphics 1704i provides a function for drawing, on the graphics plane 1314, graphics instructed to be drawn by a Java program included in a service, via the library 1701b. This is implemented by the Java Abstract Window Toolkit (AWT) function. Graphics drawn on the graphics plane 1314 are transferred to the display 1305 and displayed thereon with appropriate frequency instructed by the CPU.

The trick play manager 1704g monitors the trick play state of a service which is currently being reproduced, and instructs the AM 1704b to control a Java program included in the service in accordance with the change in the state.

FIG. 27 is a diagram showing a detailed configuration of the is trick play manager 1704g.

The trick play start/end determination unit 2701 determines start and end of trick play such as fast-forward, rewind, slow playback, or pause. In the case where the JMF 1704a has changed the reading speed of an MPEG-2 transport stream in response to a request from a Java program, the trick play start/end determination unit 2701 is notified of the reading speed before the change and the reading speed after the change from the JMF 1704a, and determines start or end of trick play. In the case where the reading speed has been changed from 1.0 times speed to a higher or lower speed than 1.0 times speed, the trick play start/end determination unit 2701 determines start of trick play, while in the case where the reading speed has been changed from a higher or lower speed than 1.0 times speed to the 1.0 times speed, it determines end of trick play. For example, if the reading speed of an MPEG-2 transport stream has been changed from 1.0 times speed to 2.0 times speed, the trick play start/end determination unit 2701 determines that trick play has started. Conversely, if the reading speed of an MPEG-2 transport stream has been changed from 2.0 times speed to 1.0 times speed, the trick play start/end determination unit 2701 determines that trick play has ended. If the determination result is either the start or end of trick play, the trick play start/end determination unit 2701 passes the determination result to the trick play interval processing management unit 2703.

The trick play interval processing management unit 2703 instructs the trick play interval processing unit 2702 to perform trick play start/end processing for the Java program, based on the determination result made by the trick play start/end determination unit 2701 or the updated AIT notified by the AIT monitoring unit 2711. More specifically, the trick play interval processing management unit 2703 passes a Java program identifier to be processed and a trick play flag value to the trick play interval processing unit 2702 for performing the processing.

First, descriptions are given below of the case where the trick play interval processing management unit 2703 instructs the trick play interval processing unit 2702 to perform trick play start/end processing on a Java program, based on the determination result made by the trick play start/end determination unit 2701.

The trick play interval processing management unit 2703 has in itself a buffer for temporarily storing trick play interval processing information that is a list of data such as a flag.

When notified of the determination result from the trick play start/end determination unit 2701, the trick play interval processing management unit 2703 first specifies a Java program identifier corresponding to a Java program to be processed, with reference to trick play interval processing information held in itself.

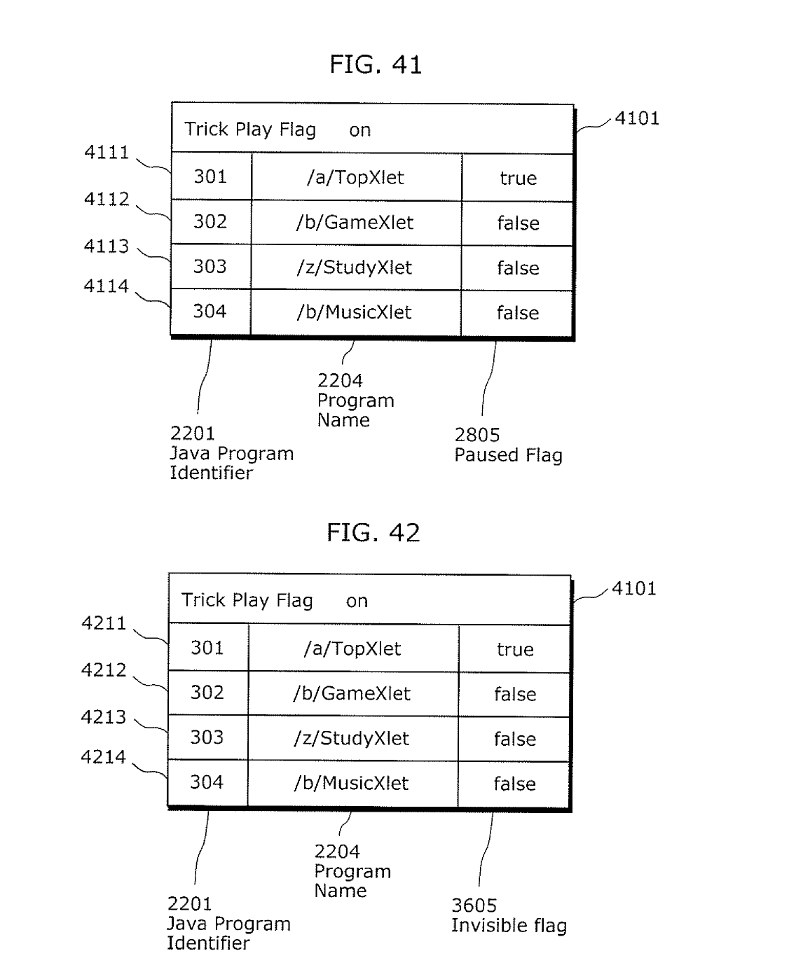

FIG. 41 shows an example of trick play interval processing information held in the trick play interval processing management unit 2703. In FIG. 41, columns 2201, 2204, 2205 and 4101 show a Java program identifier, the corresponding program name, a paused flag and a trick play flag, respectively.

A trick play flag is a flag indicating whether or not reproduction of an MPEG-2 transport stream is in a trick play mode at this point in time. A trick play flag value of “on” means that the reproduction is in a trick play mode at this point in time, while a trick play flag value of “off” means that the reproduction is not in the trick play mode at this point in time. The trick play flag is updated based on the result notified from the trick play start/end determination unit 2701. To be more specific, when the trick play start/end determination unit 2701 determines that trick play has started, the trick play flag value is updated to “on”, while when it determines that trick play has ended, the trick play flag value is updated to “off”.

The paused flag is a flag that indicates whether or not the corresponding Java program is to be paused during trick play operation. The paused flag value of “true” means that the corresponding Java program is to be paused during trick play. For example, by referring to FIG. 41, since a Java program “/a/TopXlet” corresponding to a Java program identifier of “301” has its paused flag value of “true”, the Java program is paused during trick play.

The trick play interval processing management unit 2703 specifies a Java program identifier to be passed to the trick play interval processing unit 2702, based on the above-mentioned paused flag. More specifically, the trick play interval processing management unit 2703 passes, to the trick play interval processing unit 2702, the Java program identifier with the paused flag value of “true” being set, together with the trick play flag value. For example, by referring to FIG. 41 here, the Java program identifier with the paused flag value of “true” is “301”. In the case where the trick play start/end determination unit 2701 determines that trick play has started, the trick play interval processing management unit 2703 passes, to the trick play interval processing unit 2702, the result indicating that trick play has started, namely, the trick play flag value of “on”, as well as the Java program identifier, and instructs the trick play interval processing unit 2702 to perform processing for pausing the Java program corresponding to that Java program identifier. In the case where the trick play start/end determination unit 2701 determines that trick play has ended, the trick play interval processing management unit 2703 passes, to the trick play interval processing unit 2702, the result indicating that trick play has ended, namely, the trick play flag value of “off”, as well as the Java program identifier, and instructs the trick play interval processing unit 2702 to perform processing for resuming the Java program which has been paused and corresponds to that Java program identifier.

Next, descriptions are given below of the case where the trick play interval processing management unit 2703 instructs the trick play interval processing unit 2702 to perform trick play start/end processing on a Java program, based on the updated AIT notified from the AIT monitoring unit 2711.

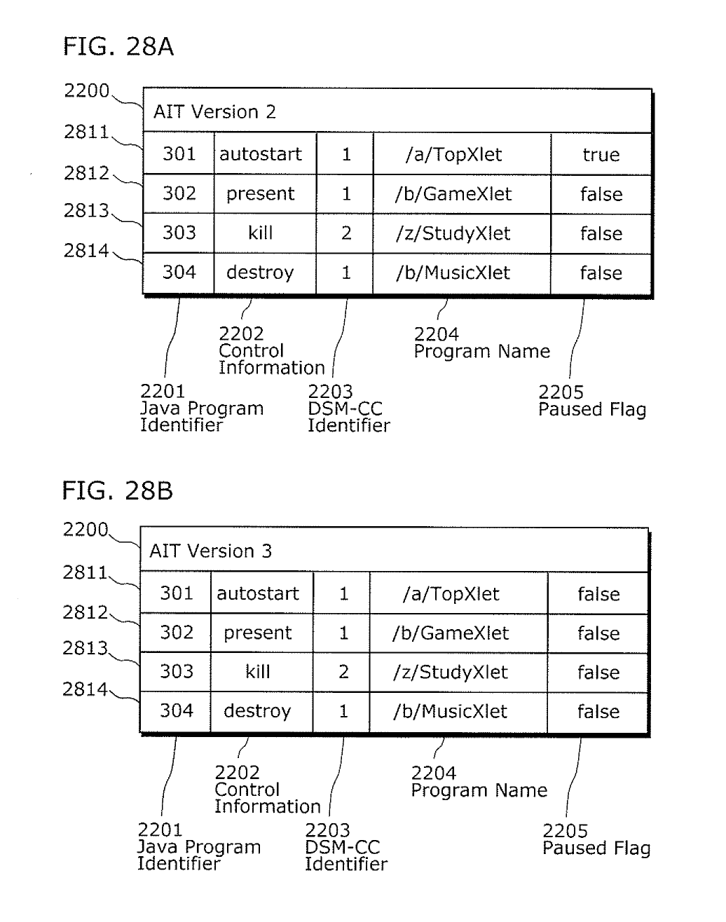

FIG. 28A or FIG. 28B shows an example of an AIT notified from the AIT monitoring unit 2711 of the AM 1704b. Every time an AIT is updated, the AIT monitoring unit 2711 notifies the trick play interval processing management unit 2703 of the updated AIT. First, in order to determine whether the paused flag value has been changed, the trick play interval processing unit 2703 saves trick play interval processing information including the paused flag value at that point in time into a buffer before updating. Next, the trick play interval processing unit 2703 analyzes the notified AIT, and updates a paused flag corresponding to each Java program in trick play interval processing information held in the trick play interval processing management unit 2703. For example, in the case where the AIT shown in FIG. 28B is detected after the AIT shown in FIG. 28A was detected by the AIT monitoring unit 2711, a paused flag value corresponding to the Java program identifier of “301” in trick play interval processing information held in the trick play interval processing management unit 2703 is updated from “true” to “false”.

When the trick play interval processing information was updated, the trick play interval processing management unit 2703 compares the paused flag value saved on the buffer and the paused flag value in the trick play interval processing information, and determines Java programs having the paused flag value changed by the update. If the paused flag value has not been changed, nothing is done. If the paused flag value has been changed, the trick play interval processing management unit 2703 holds the changed value, and then determines whether or not trick play is in progress at the present moment based on the trick play flag in the trick play interval processing information. If the trick play flag value is “off” namely trick play is not in progress at the present moment, nothing is done. If the trick play flag value is “on”, namely trick play is in progress at the present moment, the trick play interval processing management unit 2703 determines whether the paused flag value has been changed from “true” to “false”, or from “false” to “true”.

In the former case, namely in the case where the paused flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that paused flag, and instructs the trick play interval processing unit 2702 to perform processing for resuming the Java program which has been paused and corresponds to that Java program identifier.

In the latter case, namely in the case where the paused flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that paused flag, and instructs the trick play interval processing unit 2702 to perform processing for pausing the Java program corresponding to that Java program identifier.

The trick play interval processing unit 2702 receives the Java program identifier to be processed and the trick play flag value from the trick play interval processing management unit 2703, and performs processing appropriate for the Java program corresponding to that Java program identifier. If the trick play flag value is “on”, the trick play interval processing unit 2702 calls, using the Java program identifier as an argument, a pause method provided by the application state management unit 2712, and instructs to pause the Java program corresponding to that Java program identifier. On the contrary, if the trick play flag value is “off”, the trick play interval processing unit 2702 calls, using the Java program identifier as an argument, a resume method provided by the application state management unit 2712, and instructs to resume the Java program corresponding to that Java program identifier.

For example, by referring to FIG. 41, in the case where the trick play interval processing management unit 2703 passes the Java program identifier of “301” and the trick play flag value of “on” to the trick play interval processing unit 2702, the trick play interval processing unit 2702 calls, using the Java program identifier of “301” as an argument, the pause method provided by the application state management unit 2712 in the AM 1704b, and instructs to pause a Java program of “/a/TopXlet” corresponding to the Java program identifier of “301”, in order to pause that Java program of “/a/TopXlet” corresponding to the Java program identifier of “301”. In the case where the trick play interval processing management unit 2703 passes the Java program identifier of “301” and the trick play flag value of “off” to the trick play interval processing unit 2702, the trick play interval processing unit 2702 calls, using the Java program identifier of “301” as an argument, the resume method provided by the application state management unit 2712 in the AM 1704b, and instructs to resume a Java program of “/a/TopXlet” corresponding to the Java program identifier of “301”, in order to resume that Java program of “/a/TopXlet” corresponding to the Java program identifier of “301”.

The EPG 1702 is an Electric Program Guide, and is a function which causes a user to choose a TV show to be recorded and reproduced. Normal reproduction through receiving a broadcast wave is out of the scope of the present invention and thus description is omitted.

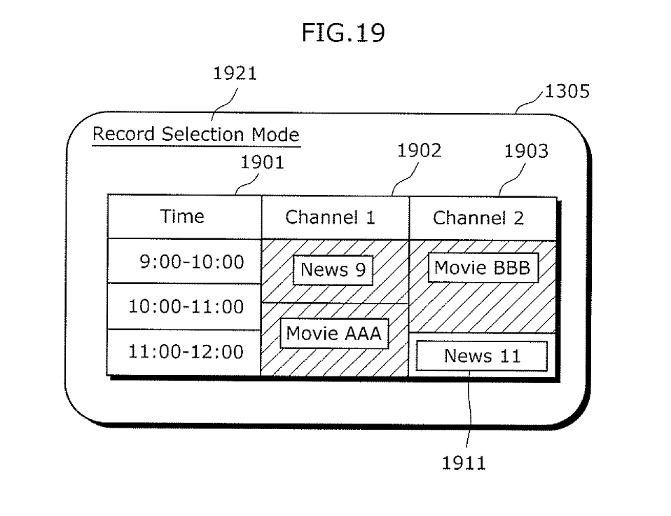

In the case of recording the TV show, the EPG 1702 displays a list of broadcasted TV shows, and causes the user to choose a desired TV show. FIG. 19 is an example of a screen display for causing selection of a TV show to be recorded. A time 1901 and channels 1902 and 1903 are displayed in a grid, and it is possible to check the TV shows of each recordable channel at each time. It is possible for the user to move a focus 1911 within the screen using top, bottom, right, and left cursor buttons 1401 to 1404, which are included in the input unit 1310 of the terminal apparatus 1300. Furthermore, when an OK button 1405 is pushed, the TV show which is currently highlighted is selected to be recorded. The EPG 1702 acquires the channel identifier of the TV show from the library, and when the TV show to be recorded is selected by the user, notifies the channel identifier, start time, and end time of the TV show to the recording manager 1704h. Based on that information, the service manager 1704h records the TV show into the secondary storage unit 1307.

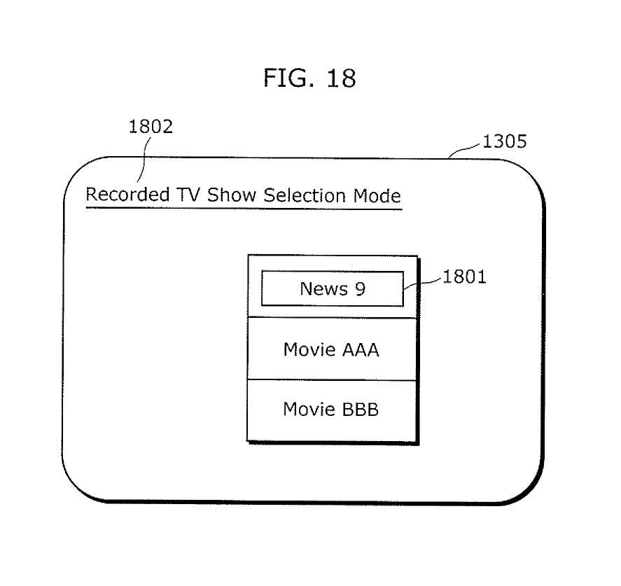

On the other hand, in the case of reproducing an already-recorded TV show, the EPG 1702 displays a list of the already-recorded TV shows, and causes the user to choose a desired TV show. FIG. 18 is an example of a screen display for causing selection of an already-recorded TV show. All TV shows stored in the secondary storage unit 1307 at that point in time are listed. It is possible for the user to move a focus 1801 within the screen using the top and bottom cursor buttons 1401 and 1402, which are included in the input unit 1310 of the terminal apparatus 1300. Furthermore, when the OK button 1405 is pushed, the TV show which is currently highlighted is selected to be reproduced. The EPG 1702 acquires the record identifier of the TV show from the recording manager 1704h, and when the TV show to be reproduced is selected by the user, it notifies the service manager 1704f of the record identifier of that TV show. Based on that information, the service manager 1704f reads out the TV show from the secondary storage unit 1307 and reproduces it.

A typical operation in the present embodiment having the above-explained configuration is described below using a flowchart.

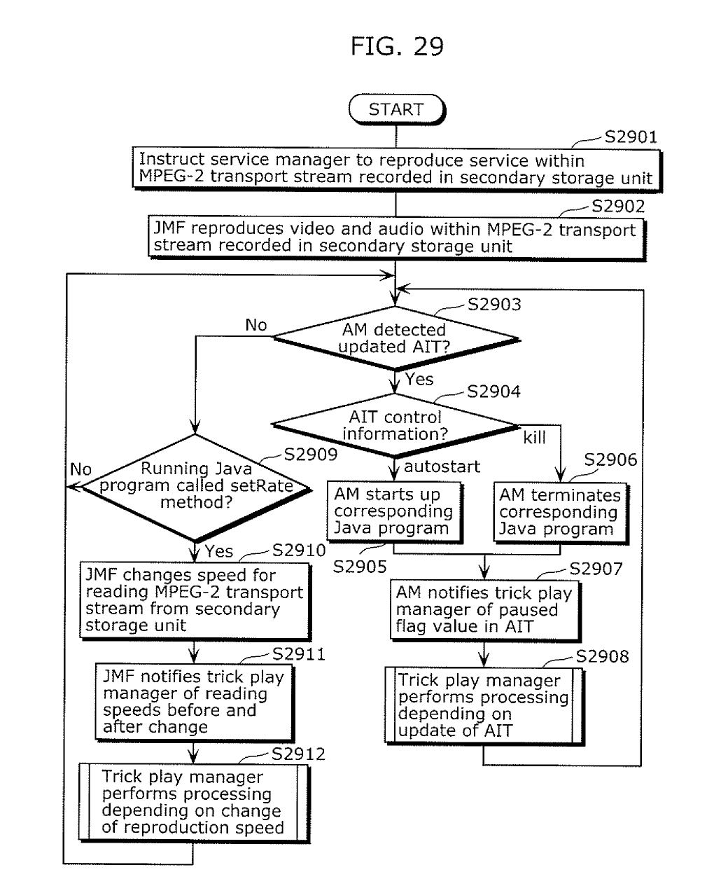

FIG. 29 is a flowchart showing the case of reproducing a service within an MPEG-2 transport stream recorded in the secondary storage unit 1307.

First, a user instructs the EPG 1702 to reproduce a service within an MPEG-2 transport stream (S2901). Thereby, the service manager 1704f is given an instruction to reproduce the service within the MPEG-2 transport stream recorded in the secondary storage unit 1307, and the record identifier identifying that service. Next, the service manager 1704f instructs the JMF 1704a to reproduce video and audio within the MPEG-2 transport stream recorded in the secondary storage unit 1307, and the JMF 1704a starts reproducing the video and audio (52902). In addition, since the service manager 1704f instructs the AM 1704b to detect an AIT within the MPEG-2 transport stream recorded in the secondary storage unit 1307, the AIT monitoring unit 2711 of the AM 1704b starts detecting an AIT (S2903).

Here, if an updated AIT is detected, the corresponding Java program is controlled based on the control information in the AIT (S2904). As for a Java program specified with control information of “autostart” in AIT, the application state management unit 2712 of the AM 1704b starts up that Java program (S2905). As for a Java program specified with control information of “kill” in AIT, the application state management unit 2712 of the AM 1704b terminates that Java program (S2906). Next, the AIT monitoring unit 2711 of the AM 1704b notifies the trick play interval processing management unit 2703 in the trick play manager 1704g of the updated AIT (S2907).

FIG. 28A and FIG. 28B each show an example of an AIT. Every time an AIT is updated, the AIT monitoring unit 2711 notifies the trick play interval processing management unit 2703 of the updated AIT. The trick play interval processing unit 2703 analyzes is the notified AIT, and updates a paused flag corresponding to each Java program in trick play interval processing information held in the trick play interval processing management unit 2703. For example, in the case where the AIT shown in FIG. 28B is detected after the AIT shown in FIG. 28A was detected by the AIT monitoring unit 2711, a paused flag value corresponding to the Java program identifier of “301” in trick play interval processing information held in the trick play interval processing management unit 2703 is updated from “true” to “false”.

Then, the trick play manager 1704g performs the processing depending on the update of the trick play interval processing information held in the trick play interval processing management unit 2703 (S2908). That processing is described later. After that, the process returns to the AIT detection by the AIT monitoring unit 2711 (S2903).

If no updated AIT is detected, it is judged whether the Java program instructed trick play or not (S2909). Here, if the Java program calls setRate ( ) using a factor of “2.0”, more specifically, if it instructs trick play, the JMF 1704a sets the speed for reading the MPEG-2 transport stream from the secondary storage unit 1307 at a double speed of the normal one (S2910). If trick play is not instructed, the process returns to the AIT detection by the AIT monitoring unit 2711 (S2903). Next, the JMF 1704a notifies the trick play start/end determination unit 2701 in the trick play manager 1704g of the MPEG-2 transport stream reading speed values before and after the change of the speed (S2911).

Then, the trick play manager 1704g performs the processing depending on the change of the reproduction speed of the MPEG-2 transport stream (S2912). That processing is described later. After that, the process returns to the AIT detection by the AIT monitoring unit 2711 (S2903).

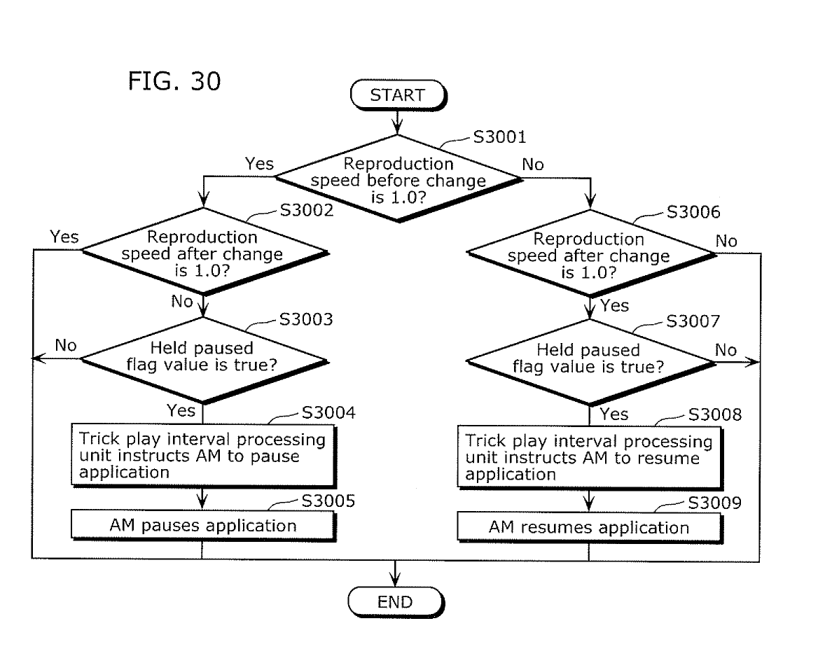

FIG. 30 is a flowchart showing a flow of processing performed is by the trick play manager 1704g depending on a change in reproduction speed of an MPEG-2 transport stream.

In the case where setRate ( ) is called by a Java program so as to change a reproduction speed of an MPEG-2 transport stream, when the JMF 1704a notifies the trick play start/end determination unit 2701 in the trick play manager 1704g of the reproduction speeds before and after the change, the trick play start/end determination unit 2701 first determines whether the reproduction speed before the change is “1.0” or not (S3001). If the reproduction speed before the change is “1.0”, the trick play start/end determination unit 2701 further determines whether the reproduction speed after the change is “1.0” or not (S3002), and if the reproduction speed after the change is not “1.0”, it determines that trick play has started. Then, it passes its determination result to the trick play interval processing management unit 2703. If the reproduction speed after the change is “1.0”, nothing is done.

Upon receiving the result that trick play has started, the trick play interval processing management unit 2703 determines whether or not there is a Java program identifier having a paused flag value of “true” in the trick play interval processing information held in itself (S3003). By referring to FIG. 41 here, the Java program identifier with the paused flag value of “true” is “301”. The trick play interval processing management unit 2703 passes, to the trick play interval processing unit 2702, the result indicating that trick play has started, namely, the trick play flag value of “on”, as well as the Java program identifier, and instructs the trick play interval processing unit 2702 to perform processing for pausing the Java program corresponding to that Java program identifier (S3004). The trick play interval processing unit 2702 calls, using the Java program identifier of “301” as an argument, a pause method provided by the application state management unit 2712 in the AM 1704b, and instructs to pause the Java program corresponding to that Java program identifier (S3005).

If the reproduction speed before the change is not “1.0”, the trick play start/end determination unit 2701 further determines whether the reproduction speed after the change is “1.0” or not (S3006), and if the reproduction speed after the change is “1.0”, it determines that trick play has ended. Then, it passes its determination result to the trick play interval processing management unit 2703. If the reproduction speed after the change is not “1.0”, nothing is done.

Upon receiving the result that trick play has ended, the trick play interval processing management unit 2703 determines whether or not there is a Java program identifier having a paused flag value of “true” in the trick play interval processing information held in itself (S3007). By referring to FIG. 41 here, the Java program identifier with the paused flag value of “true” is “301”. The trick play interval processing management unit 2703 passes, to the trick play interval processing unit 2702, the result indicating that trick play has ended, namely, the trick play flag value of “off”, as well as the Java program identifier, and instructs the trick play interval processing unit 2702 to perform processing for resuming the Java program which has been paused and corresponds to that Java program identifier (S3008). The trick play interval processing unit 2702 calls, using the Java program identifier of “301” as an argument, a resume method provided by the application state management unit 2712 in the AM 1704b, and instructs to resume the Java program which has been paused and corresponds to that Java program identifier (S3009).

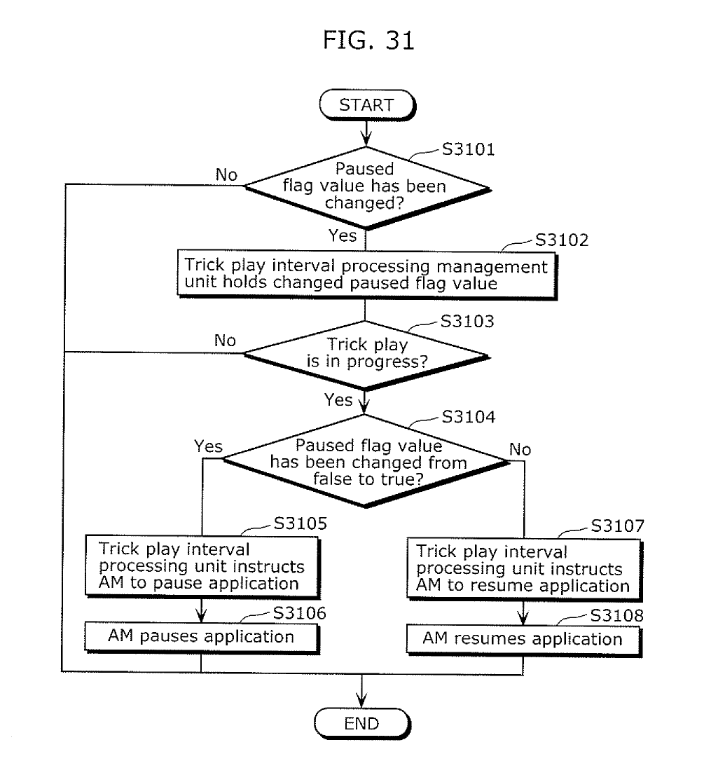

FIG. 31 is a flowchart showing a flow of processing performed by the trick play manager 1704g depending on an update of trick play interval processing information held in the trick play interval processing management unit 2703.

In the case where an updated AIT is detected, when the trick 1s play interval processing information held in the trick play interval processing management unit 2703 is updated, the trick play interval processing management unit 2703 determines whether or not a paused flag value corresponding to any Java program has been changed (S3101). Here, in order to determine whether the paused flag value has been changed or not, the trick play interval processing management unit 2703 saves trick play interval processing information including the paused flag value at that point in time into a buffer before updating it. The trick play interval processing management unit 2703 compares the paused flag value saved on the buffer and the paused flag value included in the trick play interval processing information, and determines, based on the values before and after the update, whether the paused flag value has been changed or not. If the paused flag value has not been changed, nothing is done. If the paused flag value has been changed, the trick play interval processing management unit 2703 holds the changed value (S3102), and then determines whether or not trick play is in progress at the present moment based on the trick play flag in the trick play interval processing information (S3103).

If the trick play flag value is “off”, namely trick play is not in progress at the present moment, nothing is done. If the trick play flag value is “on”, namely trick play is in progress at the present moment, the trick play interval processing management unit 2703 determines whether the paused flag value has been changed from “true” to “false”, or from “false” to “true” (S3104). In the latter case, namely in the case where the paused flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that paused flag, and instructs the trick play interval processing unit 2702 to perform processing for pausing the Java program corresponding to that Java program identifier (S3105). The trick play interval processing unit 2702 calls, using the Java program identifier of “301” as an argument, a pause method provided by the application state management unit 2712 in the AM 1704b, and instructs to pause the Java program corresponding to that Java program identifier (S3106).

In the former case, namely in the case where the paused flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that paused flag, and instructs the trick play interval processing unit 2702 to perform processing for resuming the Java program which has been paused and corresponds to that Java program identifier (S3107). The trick play interval processing unit 2702 calls, using the Java program identifier of “301” as an argument, a resume method provided by the application state management unit 2712 in the AM 1704b, and instructs to resume the Java program which has been paused and corresponds to that Java program identifier (S3108).

As described above, according to the first embodiment, a Java program to which a paused flag is set is shifted to a paused state during trick play, and thus it is possible to prevent an unexpected behavior of the Java program during trick play.

(Second Embodiment)

Hereafter, an apparatus and a method according to the second embodiment of the present invention are described with reference to the drawings.

Since the hardware configuration and the like used in the second embodiment are same as those in the first embodiment of the present invention, FIG. 1 to FIG. 16 are used here again. As the constituent elements in these diagrams have the same functions as the constituent elements of the same names and the same reference numbers in the first embodiment, descriptions are not repeated.

The software configuration of the second embodiment is same as that shown in FIG. 17. As the constituent elements other than the AM 1704b and the trick play manager 1704g have the same functions as the constituent elements of the same names and the same reference numbers in the software configuration of the first embodiment, descriptions are not repeated. As various data formats used in the second embodiment are same as those shown in FIG. 20 to FIG. 22 and FIG. 41, descriptions are not repeated.

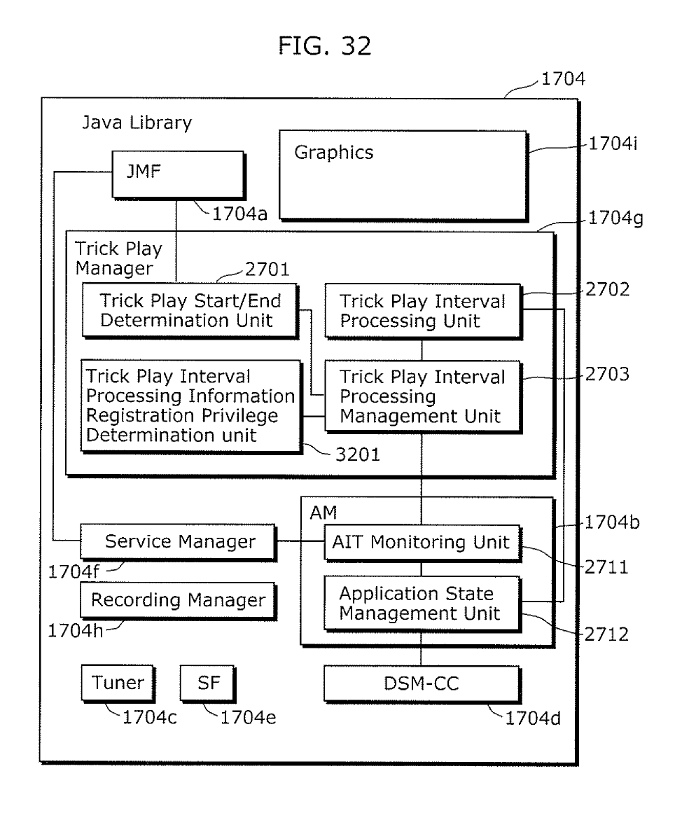

FIG. 32 is a diagram showing a detailed configuration of the AM 1704b and the trick play manager 1704g in the Java library 1704.

The AM 1704b is configured of an AIT monitoring unit 2711 and an application state management unit 2712. As the application state management unit 2712 has the same functions as in the first embodiment, descriptions are not repeated.

The AIT monitoring unit 2711 monitors AIT update state, using an MPEG-2 transport stream and a channel identifier as inputs, as in the first embodiment. In the first embodiment, if an AIT is updated, the updated AIT is notified to the trick play interval processing management unit 2703 and the application state management unit 2712. However, in the present embodiment, the updated AIT is notified only to the application state management unit 2712. Except an operation of notifying the trick play interval processing management unit 2703 of the updated AIT, the operations of the AIT monitoring unit 2711 in the present embodiment are same as the operations of the AIT monitoring unit 2711 in the first embodiment.

The trick play manager 1704g is comprised of a trick play start/end determination unit 2701, a trick play interval processing unit 2702, a trick play interval processing management unit 2703 and a trick play interval processing information registration privilege determination unit 3201. As the trick play start/end determination unit 2701 and the trick play interval processing unit 2702 respectively have the same functions as in the first embodiment, descriptions are not repeated.

As in the first embodiment, the trick play interval processing management unit 2703 holds trick play interval processing information in which trick play start/end processing for each Java program is described, and also instructs the trick play interval processing unit 2702 to perform trick play start/end processing for an appropriate Java program based on that trick play interval processing information. In the first embodiment, if an AIT is updated, the updated AIT is notified from the AIT monitoring unit 2711, and based on that AIT, a paused flag in the held trick play interval processing information is updated. However, in the present embodiment, even if the AIT is updated, the updated AIT is not notified from the AIT monitoring unit 2711. The trick play interval processing management unit 2703 provides, as JavaAPI, a method “setPausingFlag(int appID, Boolean pausingFlag)” having a paused flag value as an argument.

Here, an argument appID is a Java program identifier to be set with a paused flag value, and an argument pausingFlag is a paused flag value. When the setPausingFlag method is called by a Java program, the paused flag in the held trick play interval processing information is updated. For example, setPausingFlag (301, true) is called by a Java program, the paused flag corresponding to a Java program having a Java program identifier of “301” is set to “true”. On the other hand, setPausingFlag (301, false) is called by a Java program, the paused flag corresponding to the Java program having the Java program identifier of “301” is set is to “false”.

When the setPausingFlag method is called, the trick play interval processing management unit 2703 first passes the Java program identifier of the caller Java program to the trick play interval processing information registration privilege determination unit 3201, in order to determine whether or not the caller Java program has a privilege, that is, a permission of updating a paused flag. The trick play interval processing information registration privilege determination unit 3201 returns its determination result whether or not the Java program to which its identifier was passed has a privilege of updating the paused flag.

If the determination result sent from the trick play interval processing information registration privilege determination unit 3201 indicates that the caller Java program does not have a privilege of updating the paused flag, the trick play interval processing management unit 2703 returns the fact to the caller Java program. On the other hand, if the determination result indicates that the caller Java program has a privilege of updating the paused flag, the trick play interval processing management unit 2703 saves trick play interval processing information including the paused flag value at that point in time on a buffer, and sets the paused flag value specified by the Java program thereto. Next, the trick play interval processing management unit 2703 determines whether or not the paused flag value corresponding to the Java program has been changed. The trick play interval processing management unit 2703 compares the paused flag value saved on the buffer and the paused flag value included in the trick play interval processing information, and determines Java programs having the paused flag value changed by the update. If the paused flag value has not been changed, nothing is done. If the paused flag value has been changed, the trick play interval processing management unit 2703 holds the changed value, and then determines whether or not trick play is in progress at the present moment based on the trick play flag in the trick play interval processing information. If the trick play flag value is “off”, namely trick play is not in progress at the present moment, nothing is done. If the trick play flag value is “on”, namely trick play is in progress at the present moment, the trick play interval processing management unit 2703 determines whether the paused flag value has been changed from “true” to “false”, or from “false” to “true”.

In the former case, namely in the case where the paused flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that paused flag, and instructs the trick play interval processing unit 2702 to perform processing for resuming the Java program which has been paused and corresponds to that Java program identifier.

In the latter case, namely in the case where the paused flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that paused flag, and instructs the trick play interval processing unit 2702 to perform processing for pausing the Java program corresponding to that Java program identifier.

The trick play interval processing information registration privilege determination unit 3201 determines whether or not the Java program corresponding to the specified Java program identifier has a privilege of updating the paused flag in the trick play interval processing information. Upon receiving the Java program identifier passed from the trick play interval processing management unit 2703, the trick play interval processing information registration privilege determination unit 3201 determines whether or not the Java program corresponding to that Java program identifier has a permission for updating the paused flag in the trick play interval processing information, and then, if it has the permission, permits the trick play interval processing management unit 2703 to update the paused flag in the trick play interval processing information.

Here, the privilege, namely the permission to update the paused flag in the trick play interval processing information can be set with, for example, MonitorAppPermission and the like in the OCAP specifications. This is a method in which a permission description file is also stored in a directory where a Java program is stored and a list of privileges permitted for the Java program is included in the permission description file. For example, if an application name of a Java program is described in a file named ocap.applicationname.perm in a format such as <ocap:monitorapplication name=“setPausingFlag” value=true></ocap:monitorapplication>, the Java program identified with such application name can have a privilege of updating a paused flag in trick play interval processing information.

First, a Java program calls a setPausingFlag method provided by the trick play interval processing management unit 2703 in the trick play manager 1704g, and requests to set the paused flag value in the trick play interval processing information. The trick play interval processing management unit 2703 passes, to the trick play interval processing information registration privilege determination unit 3201, the Java program identifier corresponding to the Java program which calls the setPausingFlag method, so as to determine whether or not that Java program has a privilege of updating the paused flag. Here, if the Java program does not have a privilege of updating the paused flag, the trick play interval processing information registration privilege determination unit 3201 returns the fact to the trick play interval processing management unit 2703, and ends the process. If the Java program has a privilege of updating the paused flag, the trick play interval processing information registration privilege determination unit 3201 returns the fact to the trick play interval processing management unit 2703.

A typical operation in the present embodiment having the above-explained configuration is described below using a flowchart.

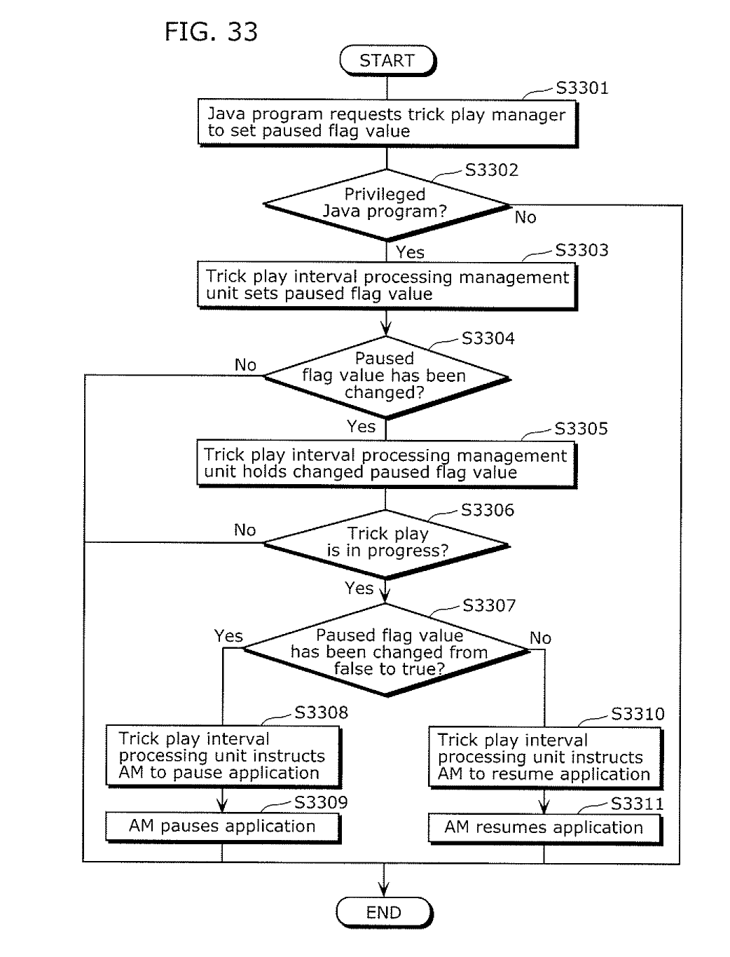

FIG. 33 is a flowchart showing the case where a Java program instructs the trick play manager 1704g to update a paused flag in trick play interval processing information.

First, a Java program calls a setPausingFlag method provided by the trick play interval processing management unit 2703 in the trick play manager 1704g, and requests to set the paused flag value in the trick play interval processing information (S3301). The trick play interval processing management unit 2703 passes, to the trick play interval processing information registration privilege determination unit 3201, the Java program identifier corresponding to the Java program which calls the setPausingFlag method, so as to determine whether or not that Java program has a privilege of updating the paused flag (S3302). Here, if the Java program does not have a privilege of updating the paused flag, the trick play interval processing information registration privilege determination unit 3201 returns the fact to the trick play interval processing management unit 2703, and ends the process. If the Java program has a privilege of updating the paused flag, the trick play interval processing information registration privilege determination unit 3201 returns the fact to the trick play interval processing management unit 2703, and sets the paused flag value specified by that Java program (S3303). Here, the trick play interval processing management unit 2703 determines whether or not the paused flag value corresponding to the Java program has been changed (S3304). Here, in order to determine whether the paused flag value has been changed or not, the trick play interval processing management unit is 2703 saves trick play interval processing information including the paused flag value at that point in time into a buffer before updating it. The trick play interval processing management unit 2703 compares the paused flag value saved on the buffer and the paused flag value included in the trick play interval processing information, and determines, based on the values before and after the update, whether the paused flag value has been changed or not.

Here, if the paused flag value has not been changed, nothing is done. If the paused flag value has been changed, the trick play interval processing management unit 2703 holds the changed value (S3305), and then determines whether or not trick play is in progress at the present moment based on the trick play flag in the trick play interval processing information (S3306). If the trick play flag value is “off”, namely trick play is not in progress at the present moment, nothing is done. If the trick play flag value is “on”, namely trick play is in progress at the present moment, the trick play interval processing management unit 2703 determines whether the paused flag value has been changed from “true” to “false”, or from “false” to “true” (S3307). In the latter case, namely in the case where the paused flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that paused flag, and instructs the trick play interval processing unit 2702 to perform processing for pausing the Java program corresponding to that Java program identifier (S3308). The trick play interval processing unit 2702 calls, using the Java program identifier of “301” as an argument, a pause method provided by the application state management unit 2712 in the AM 1704b, and instructs to pause the Java program corresponding to that Java program identifier (S3309).

In the former case, namely in the case where the paused flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that paused flag, and instructs the trick play interval processing unit 2702 to perform processing for resuming the Java program which has been paused and corresponds to that Java program identifier (S3310). The trick play interval processing unit 2702 calls, using the lava program identifier of “301” as an argument, a resume method provided by the application state management unit 2712 in the AM 1704b, and instructs to resume the Java program which has been paused and corresponds to that Java program identifier (S3311).

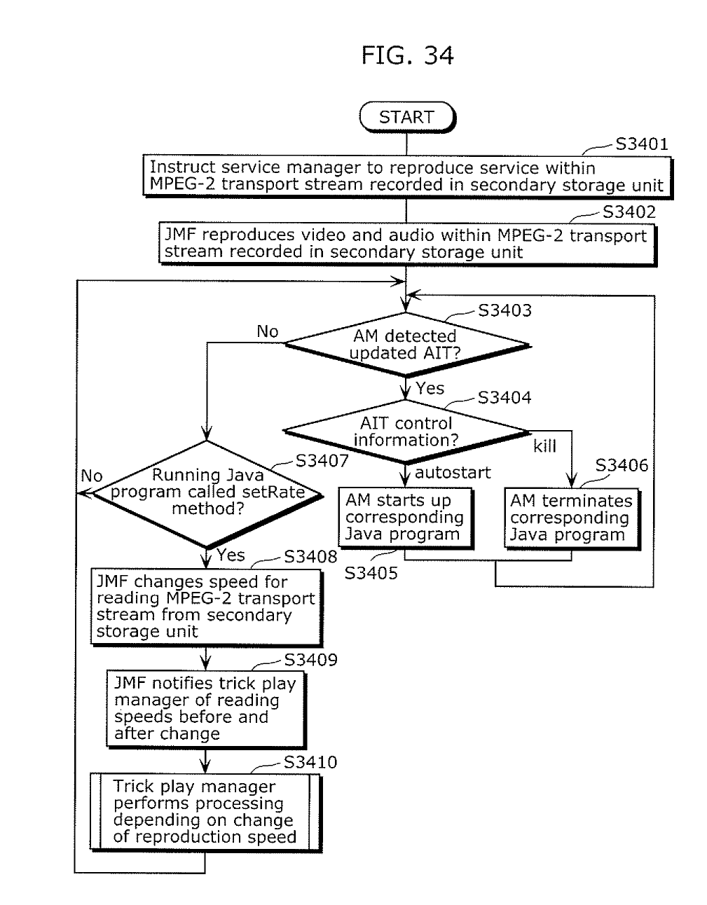

FIG. 34 is a flowchart showing the case of reproducing a service within an MPEG-2 transport stream recorded in the secondary storage unit 1307.

First, a user instructs the EPG 1702 to reproduce a service within an MPEG-2 transport stream (S3401). Thereby, the service manager 1704f is given an instruction to reproduce the service within the MPEG-2 transport stream recorded in the secondary storage unit 1307, and the record identifier identifying that service, Next, the service manager 1704f instructs the JMF 1704a to reproduce video and audio within the MPEG-2 transport stream recorded in the secondary storage unit 1307, and the JMF 1704a starts reproducing the video and audio (S3402). In addition, since the service manager 1704f instructs the AM 1704b to detect an AIT within the MPEG-2 transport stream recorded in the secondary storage unit 1307, the AIT monitoring unit 2711 of the AM 1704b starts detecting an AIT (S3403).

Here, if an updated AIT is detected, the corresponding Java program is controlled based on the control information in the AIT (S3404). As for a Java program specified with control information of “autostart” in AIT, the application state management unit 2712 of the AM 1704b starts up that Java program (S3405). As for a Java program specified with control information of “kill” in AIT, the application state management unit 2712 of the AM 1704b terminates that Java program (S3406). After that, the process returns to the AIT detection by the AIT monitoring unit 2711 (S3403).

If no updated AIT is detected, it is judged whether the Java program instructed trick play or not (S3407). Here, if the Java program calls setRate ( ) using a factor of “2.0”, more specifically, if it instructs trick play, the JMF 1704a sets the speed for reading the MPEG-2 transport stream from the secondary storage unit 1307 at a double speed of the normal one (S3408). If trick play is instructed, the process returns to the AIT detection by the AIT monitoring unit 2711 (S3403). Next, the JMF 1704a notifies the trick play start/end determination unit 2701 in the trick play manager 1704g of the MPEG-2 transport stream reading speed values before and after the change of the speed (S3409).

Then, the trick play manager 1704g performs the processing depending on the change of the reproduction speed of the MPEG-2 transport stream (53410). As the processing is same as in the first embodiment, descriptions are not repeated with reference to FIG. 30. After that, the process returns to the AIT detection by the AIT monitoring unit 2711 (S3403).

As described above, according to the second embodiment, a Java program to which a paused flag is set is shifted to a paused state during trick play, and thus it is possible to prevent an unexpected behavior of the Java program during trick play. In addition, since a Java program sets a paused flag, it is possible to control the paused flag more flexibly than the control of the paused flag by AIT.

(Third Embodiment)

Hereafter, an apparatus and a method according to the third embodiment of the present invention are described with reference to the drawings.

Since the hardware configuration and the like used in the third embodiment are same as those in the first embodiment of the present invention, FIG. 1 to FIG. 16 are used here again. As the constituent elements in this diagram have the same functions as the constituent elements of the same names and the same reference numbers in the first embodiment, descriptions are not repeated.

The software configuration of the third embodiment is same as that shown in FIG. 17. As the constituent elements other than the AM 1704b, the trick play manager 1704g and the graphics 1704i have the same functions as the constituent elements of the same names and the same reference numbers in the software configuration of the first embodiment, descriptions are not repeated. As various data formats used in the third embodiment are same as shown in FIG. 20 to FIG. 21 except FIG. 22 and FIG. 41, descriptions are not repeated.

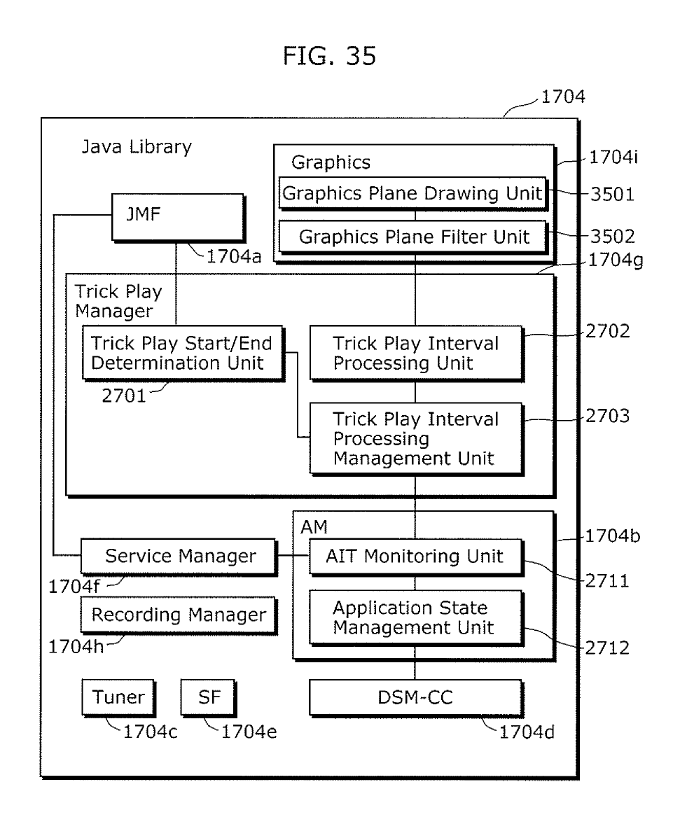

FIG. 35 is a diagram showing detailed configurations of the AM 1704b, the trick play manager 1704g and the graphics 1704i in the Java library 1704.

The AM 1704b is configured of the AIT monitoring unit 2711 and the application state management unit 2712, as in the first embodiment. As the AIT monitoring unit 2711 has the same functions as in the first embodiment, descriptions are not repeated.

In the first embodiment, the application state management unit 2712 manages the Java program execution state by accepting a request from the trick play interval processing unit 2702 or by analyzing the details of the updated AIT passed from the AIT monitoring unit 2711. However, in the present embodiment, it manages the Java program execution state only by analyzing the details of the updated AIT passed from the AIT monitoring unit 2711. Except an operation of accepting the request from the trick play interval processing unit 2702, the operations of the AIT monitoring unit 2712 in the present embodiment are same as the operations of the AIT monitoring unit 2712 in the first embodiment.

The trick play manager 1704g is comprised of the trick play start/end determination unit 2701, the trick play interval processing unit 2702, and the trick play interval processing management unit 2703. As the trick play start/end determination unit 2701 has the same functions as in the first embodiment, descriptions are not repeated.

The trick play interval processing management unit 2703 instructs the trick play interval processing unit 2702 to perform trick play start/end processing on the Java program, based on the determination result made by the trick play start/end determination unit 2701 or the updated AIT notified by the AIT monitoring unit 2711. More specifically, the trick play interval processing management unit 2703 passes a Java program identifier to be processed and a trick play flag value to the trick play interval processing unit 2702 so as to cause it to process them.

First, descriptions are given below of the case where the trick play interval processing management unit 2703 instructs the trick play interval processing unit 2702 to perform trick play start/end processing on a Java program, based on the determination result made by the trick play start/end determination unit 2701.

When notified of the determination result from the trick play start/end determination unit 2701, the trick play interval processing management unit 2703 first identifies a Java program identifier corresponding to a Java program to be processed, with reference to trick play interval processing information held in itself.

FIG. 42 shows an example of trick play interval processing information held in the trick play interval processing management unit 2703. In FIG. 42, columns 2201, 2204, 2205 and 4101 show Java program identifiers, the corresponding program names, invisible flags and a trick play flag, respectively.

A trick play flag is a flag indicating whether or not reproduction of an MPEG-2 transport stream is in a trick play mode at this point in time, as in the first embodiment.

An invisible flag is a flag indicating whether or not to hide graphics drawn by a Java program during trick play. The value “true” of the invisible flag means that graphics drawn by the corresponding Java program is hidden in a trick play mode, and then, when the trick play is canceled to return to a normal reproduction mode, the hidden graphics drawn by the Java program is displayed again. The value “false” of the invisible flag means that graphics drawn by the corresponding Java program is continued to be displayed without being hidden even in a trick play mode. For example, by referring to FIG. 42, as a Java program “/a/TopXlet” corresponding to a Java program identifier “301” has its invisible flag value of “true”, the graphics drawn by the Java program is hidden during trick play.

The trick play interval processing management unit 2703 specifies the Java program identifier to be passed to the trick play interval processing unit 2702, based on the above-mentioned invisible flag. More specifically, the trick play interval processing management unit 2703 passes, to the trick play interval processing unit 2702, the Java program identifier with the invisible flag value of “true” being set, together with the trick play flag value. For example, by referring to FIG. 42 here, the Java program identifier with the invisible flag value of “true” is “301”. In the case where the trick play start/end determination unit 2701 determines that trick play has started, the trick play interval processing management unit 2703 passes, to the trick play interval processing is unit 2702, the result indicating that trick play has started, namely, the trick play flag value of “on”, as well as the Java program identifier, and instructs the trick play interval processing unit 2702 to perform processing for hiding the graphics drawn by that Java program. In the case where trick play is terminated, the trick play interval processing management unit 2703 passes, to the trick play interval processing unit 2702, the result indicating that trick play has ended, namely, the trick play flag value of “off”, as well as the Java program identifier, and instructs the trick play interval processing unit 2702 to perform processing for displaying again the graphics drawn by that Java program.

Next, descriptions are given of the case where the trick play interval processing management unit 2703 instructs the trick play interval processing unit 2702 to perform trick play start/end processing on a Java program, based on the updated AIT notified from the AIT monitoring unit 2711.

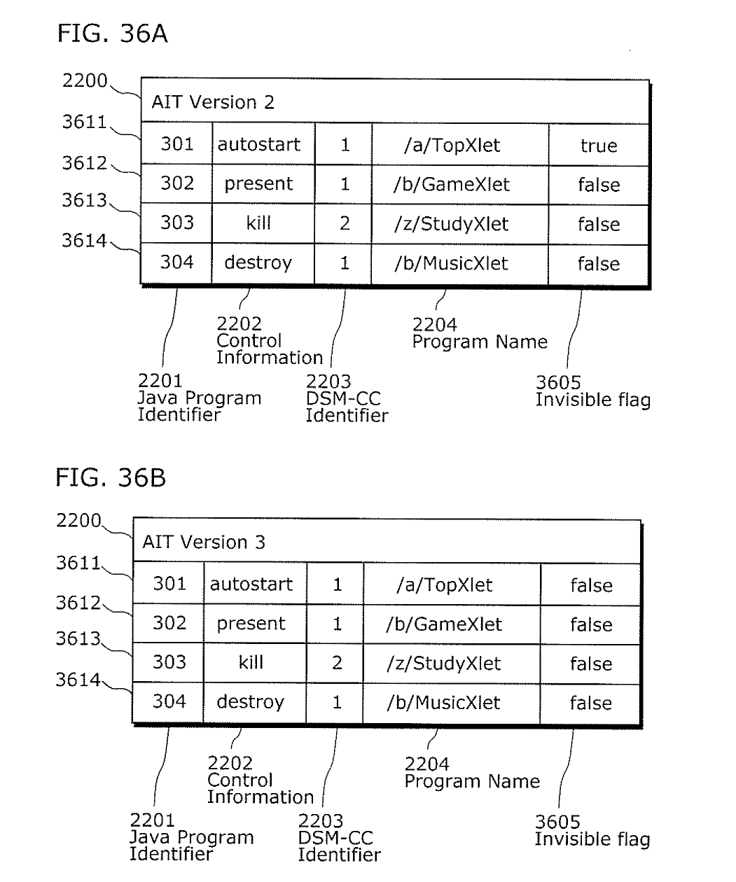

FIG. 36A and FIG. 36B each show an example of an AIT notified from the AIT monitoring unit 2711 of the AM 1704b. Since the lava program identifiers 2201, the control information 2202, the DSM-CC identifiers 2203 and the program names 2204 in FIG. 36A and FIG. 36B are same as those in the AIT in FIG. 22, descriptions are not repeated. A column 3605 shows invisible flags that correspond to respective Java programs.

Every time an AIT is updated, the AIT monitoring unit 2711 notifies the trick play interval processing management unit 2703 of the updated AIT. First, in order to determine whether the invisible flag value has been changed, the trick play interval processing management unit 2703 saves trick play interval processing information including the invisible flag value at that point in time into a buffer before updating it. Next, the trick play interval processing management unit 2703 analyzes the notified AIT, and updates an invisible flag corresponding to each Java program in the trick play interval processing information held in itself. For example, in the case where the AIT shown in FIG. 36B is detected after the AIT shown in FIG. 36A was detected by the AIT monitoring unit 2711, the invisible flag value corresponding to each Java program identifier of “301” in the trick play interval processing information held in the trick play interval processing management unit 2703 is updated from “true” to “false”.

When the trick play interval processing information was updated, the trick play interval processing management unit 2703 compares the invisible flag value saved on the buffer and the invisible flag value in the trick play interval processing information, and determines Java programs having the invisible flag value changed by the update. Here, if the invisible flag value has not been changed, nothing is done. If the invisible flag value has been changed, the trick play interval processing management unit 2703 holds the changed value, and then determines whether or not trick play is in progress at the present moment based on the trick play flag in the trick play interval processing information. If the trick play flag value is “off”, namely trick play is not in progress at the present moment, nothing is done. If the trick play flag value is “on”, namely trick play is in progress at the present moment, the trick play interval processing management unit 2703 determines whether the invisible flag value has been changed from “true” to “false”, or from “false” to “true”

In the former case, namely in the case where the invisible flag value has been changed from “true” to “false”. the trick play interval processing management unit 2703 passes, to the trick play interval processing unit 2702, the result indicating that trick play has ended, namely, the trick play flag value of “off”, as well as the Java program identifier corresponding to that invisible flag, and instructs the trick play interval processing unit 2702 to perform processing for displaying the graphics drawn by the Java program which corresponds to that Java program identifier.

In the latter case, namely in the case where the invisible flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that invisible flag, and instructs the trick play interval processing unit 2702 to perform processing for hiding the graphics drawn by the Java program which corresponds to that Java program identifier.

The trick play interval processing unit 2702 receives the Java program identifier to be processed and the trick play flag value from the trick play interval processing management unit 2703, and performs processing appropriate for the Java program corresponding to that Java program identifier. If the trick play flag value is “on”, the trick play interval processing unit 2702 calls, using the Java program identifier as an argument, a method “invalidate(int appID)” provided by the graphics plane filter unit 3502, and instructs to hide the graphics drawn on the graphics plane 1314 by the Java program corresponding to that lava program identifier. Here, an argument appID is a Java program identifier. For example, if invalidate (301) is called, graphics drawn on the graphics plane 1314 by the Java program corresponding to the Java program identifier of “301” is hidden. On the other hand, if the trick play flag value is “off”, the trick play interval processing unit 2702 calls, using the Java program identifier as an argument, a method “validate(int appID)” provided by the graphics plane filter unit 3502, and instructs to display again the graphics drawn on the graphics plane 1314 by the Java program corresponding to that Java program identifier.

Here, an argument appID is a lava program identifier. For example, if validate (301) is called, graphics drawn on the graphics plane 1314 by the Java program corresponding to the Java program identifier of “301” is displayed again.

For example, by referring to FIG. 42, in the case where the trick play interval processing management unit 2703 passes the Java program identifier of “301” and the trick play flag value of “on” to the trick play interval processing unit 2702, the trick play interval processing unit 2702 calls invalidate (301) in order to hide graphics drawn by the Java program corresponding to the Java program identifier of “301”, and instructs to invalidate graphics drawing on the graphics plane 1314 by that Java program. In the case where the trick play interval processing management unit 2703 passes the Java program identifier of “301” and the trick play flag value of “off” to the trick play interval processing unit 2702, the trick play interval processing unit 2702 calls validate (301) in order to display again graphics drawn by the Java program corresponding to the Java program identifier of “301”, and instructs to validate graphics drawing on the graphics plane 1314 by that Java program.

The graphics 1704i is comprised of the graphics plane drawing unit 3501 and the graphics plane filter unit 3502.

The graphics plane drawing unit 3501 has a function of drawing, via the library 1701b, graphics instructed to be drawn by a Java program, on the graphics plane 1314. This is implemented by the Java Abstract Window Toolkit (AWT) function. Graphics drawn on the graphics plane 1314 are transferred and displayed onto the display 1305 with appropriate frequency, according to an instruction from the CPU 1306.

The graphics plane filter unit 3502 provides a function of invalidating or validating graphics drawing on the graphics plane 1314 by the Java program corresponding to the Java program identifier passed from the trick play interval processing unit 2702.

To be more specific, the graphics plane filter unit 3502 deletes the display of the graphics drawn by the specified Java program from the display 1305. When the trick play interval processing unit 2702 calls an invalidate method using the Java program identifier as an argument, the graphics plane filter unit 3502 invalidates graphics drawing on the graphics plane 1314 by the Java program corresponding to that Java program identifier. When the trick play interval processing unit 2702 calls a validate method using the Java program identifier as an argument, the graphics plane filter unit 3502 validates graphics drawing on the graphics plane 1314 by the Java program corresponding to that Java program identifier Since graphics drawing on the graphics plane 1314 by a specific Java program is invalidated during trick play and validated during normal reproduction, according to an instruction from the trick play interval processing unit 2702, graphics instructed to be drawn by the Java program is hidden from the display 1305 during trick play.

Since a flow of processes in the case where a service within an MPEG-2 transport stream recorded in the secondary storage unit 1307 is reproduced is same as shown in the flowchart in FIG. 29 in the first embodiment, FIG. 29 is also referred to here and descriptions are not repeated.

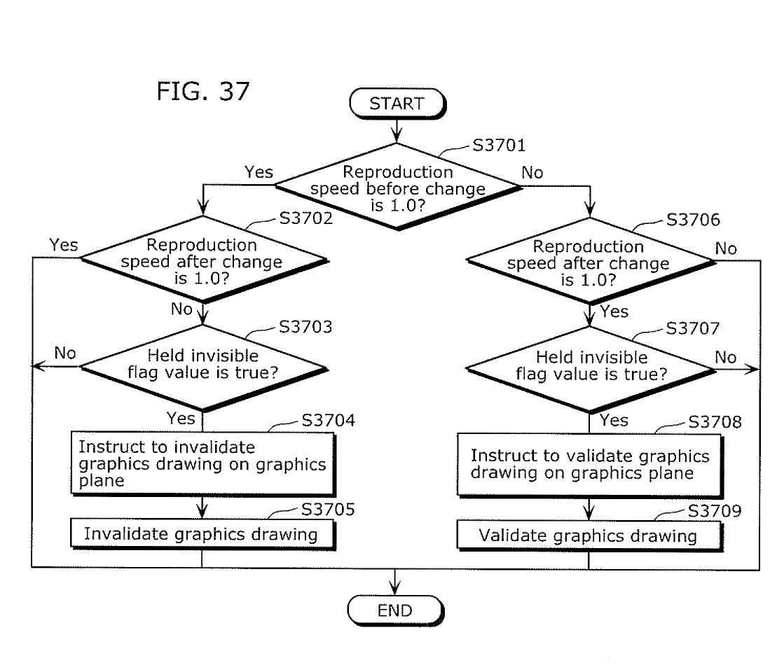

FIG. 37 is a flowchart showing a flow of processing performed by the trick play manager 1704g depending on a change in reproduction speed of an MPEG-2 transport stream.

In the case where setRate ( ) is called by a lava program so as to change a reproduction speed of an MPEG-2 transport stream, when the JMF 1704a notifies the trick play start/end determination unit 2701 in the trick play manager 1704g of the reproduction speeds before and after the change, the trick play start/end determination unit 2701 first determines whether the reproduction speed before the change is “1.0” or not (S3701). If the reproduction speed before the change is “1.0”, the trick play start/end determination unit 2701 further determines whether the reproduction speed after the change is “1.0” or not (S3702), and if the reproduction speed after the change is not “1.0” it determines that trick play has started. Then, it passes its determination result to the trick play interval processing management unit 2703. If the reproduction speed after the change is “1.0” nothing is done.

Upon receiving the result indicating that trick play has started, the trick play interval processing management unit 2703 determines whether or not there is a Java program identifier having an invisible flag value of “true” in the trick play interval processing information held in itself (S3703). By referring to FIG. 42 here, the Java program identifier with the invisible flag value of “true” is “301”. The trick play interval processing management unit 2703 passes, to the trick play interval processing unit 2702, the result indicating that trick play has started, namely, the trick play flag value of “on”, as well as the Java program identifier, and instructs the trick play interval processing unit 2702 to perform processing for hiding the graphics drawn by that Java program (S3704). The trick play interval processing unit 2702 calls, using the Java program identifier as an argument, an invalidate method provided by the graphics plane filter unit 3502, and instructs to invalidate the graphics drawing on the graphics plane 1314 by that Java program (S3705).

If the reproduction speed before the change is not “1.0”, the trick play start/end determination unit 2701 further determines whether the reproduction speed after the change is “1.0” or not (S3706), and if the reproduction speed after the change is “1.0” it determines that trick play has ended. Then, it passes its determination result to the trick play interval processing management unit 2703. If the reproduction speed after the change is not “1.0”, nothing is done.

Upon receiving the result indicating that trick play has ended, the trick play interval processing management unit 2703 determines whether or not there is a Java program identifier having an invisible flag value of “true” in the trick play interval processing information held in itself (S3707). By referring to FIG. 42 here, the Java program identifier with the invisible flag value of “true” is “301” The trick play interval processing management unit 2703 passes, to the trick play interval processing unit 2702, the result indicating that trick play has ended, namely, the trick play flag value of “off”, as well as the Java program identifier, and instructs the trick play interval processing unit 2702 to perform processing for displaying again the graphics drawn by that Java program (S3708). The trick play interval processing unit 2702 calls, using the Java program identifier as an argument, a validate method provided by the graphics plane filter unit 3502, and instructs to validate again the graphics drawing on the graphics plane 1314 by that Java program (S3709).

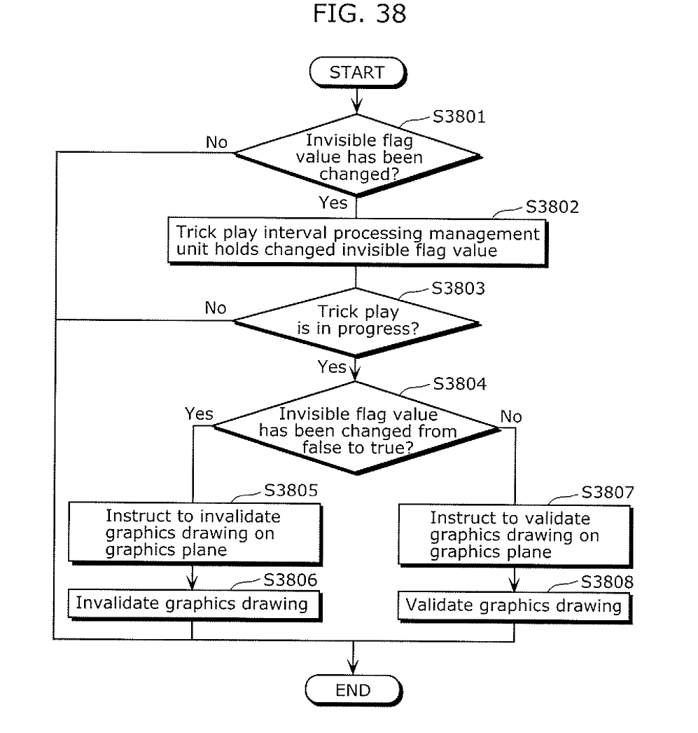

FIG. 38 is a flowchart showing a flow of processing performed by the trick play manager 1704g depending on an update of trick play interval processing information held in the trick play interval processing management unit 2703.

FIG. 36A and FIG. 36B each show an example of an AIT notified from the AIT monitoring unit 2711 of the AM 1704b. Since the Java program identifiers 2201, the control information 2202, the DSM-CC identifiers 2203 and the program names 2204 in FIG. 36A and FIG. 36B are same as those in the AIT in FIG. 22, descriptions are not repeated. A column 3605 shows invisible flags that correspond to respective Java programs. An invisible flag is a flag that indicates whether or not to hide graphics drawn by a Java program during trick play. The value “true” of the invisible flag means that graphics drawn by a Java program is hidden during trick play. For example, by referring to FIG. 36A, as a Java program “/a/TopXlet” corresponding to a Java program identifier “301”. has its invisible flag value of “true”, the graphics drawn by the Java program is hidden during trick play.

Every time an AIT is updated, the AIT monitoring unit 2711 notifies the trick play interval processing management unit 2703 of the updated AIT. The trick play interval processing unit 2703 analyzes the notified AIT, and updates an invisible flag corresponding to each Java program in the trick play interval processing information held in the trick play interval processing management unit 2703. For example, in the case where the AIT shown in FIG. 36B is detected after the AIT shown in FIG. 36A was detected by the AIT monitoring unit 2711, the invisible flag value corresponding to each Java program identifier of “301” in the trick play interval processing information held in the trick play interval processing management unit 2703 is updated from “true” to “false”.

In the case where an AIT updated from that in FIG. 36A to FIG. 36B is detected, when the trick play interval processing information held in the trick play interval processing management unit 2703 is updated, the trick play interval processing management unit 2703 determines whether or not an invisible flag value has been changed (S3801). Here, in order to determine whether the invisible flag value has been changed or not, the trick play interval processing management unit 2703 saves the trick play interval processing information including the invisible flag value at that point in time into a buffer before updating it. The trick play interval processing management unit 2703 compares the invisible flag value saved on the buffer and the invisible flag value included in the trick play interval processing information, and determines, based on the values before and after the update, whether the invisible flag value has been changed or not. Here, if the invisible flag value has not been changed, nothing is done. If the invisible flag value has been changed, the trick play interval processing management unit 2703 holds the changed value (S3802), and then determines whether or not trick play is in progress at the present moment based on the trick play flag in the trick play interval processing information (53803).

If the trick play flag value is “off”, namely trick play is not in progress at the present moment, nothing is done. If the trick play flag value is “on”, namely trick play is in progress at the present moment, the trick play interval processing management unit 2703 determines whether the invisible flag value has been changed from “true” to “false”, or from “false” to “true” (S3804). In the latter case, namely in the case where the invisible flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that invisible flag, and instructs the trick play interval processing unit 2702 to perform processing for hiding the graphics drawn by the Java program which corresponds to that Java program identifier (S3805). The trick play interval processing unit 2702 calls, using the Java program identifier as an argument, an invalidate method provided by the graphics plane filter unit 3502, and instructs to invalidate the graphics drawing on the graphics plane 1314 by the Java program (53806).

In the former case, namely in the case where the invisible flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that invisible flag, and instructs the trick play interval processing unit 2702 to perform processing for displaying again the graphics drawn by the Java program which corresponds to that Java program identifier (S3807). The trick play interval processing unit 2702 calls, using the Java program identifier as an argument, a validate method provided by the graphics plane filter unit 3502, and instructs to validate again the graphics drawing on the graphics plane 1314 by that Java program (S3808).

As described above, according to the third embodiment, graphics drawn by a Java program is hidden during trick play when an invisible flag is set, and thus it is possible to prevent distortion of graphics drawn during trick play.

(Fourth Embodiment)

Hereafter, an apparatus and a method according to the fourth embodiment of the present invention are described with reference to the drawings.

Since the hardware configuration and the like used in the fourth embodiment are same as those in the first embodiment of the present invention, FIG. 1 to FIG. 16 are used here again. As the constituent elements in these diagrams have the same functions as the constituent elements of the same names and the same reference numbers in the first embodiment, descriptions are not repeated.

The software configuration of the fourth embodiment is same as that shown in FIG. 17. As the constituent elements other than the AM 1704b and the trick play manager 1704g have the same functions as the constituent elements of the same names and the same reference numbers in the software configuration of the third embodiment, descriptions are not repeated. As various data formats used in the fourth embodiment are same as shown in FIG. 20 to FIG. 21, FIG. 36A, FIG. 36B and FIG. 42, descriptions are not repeated.

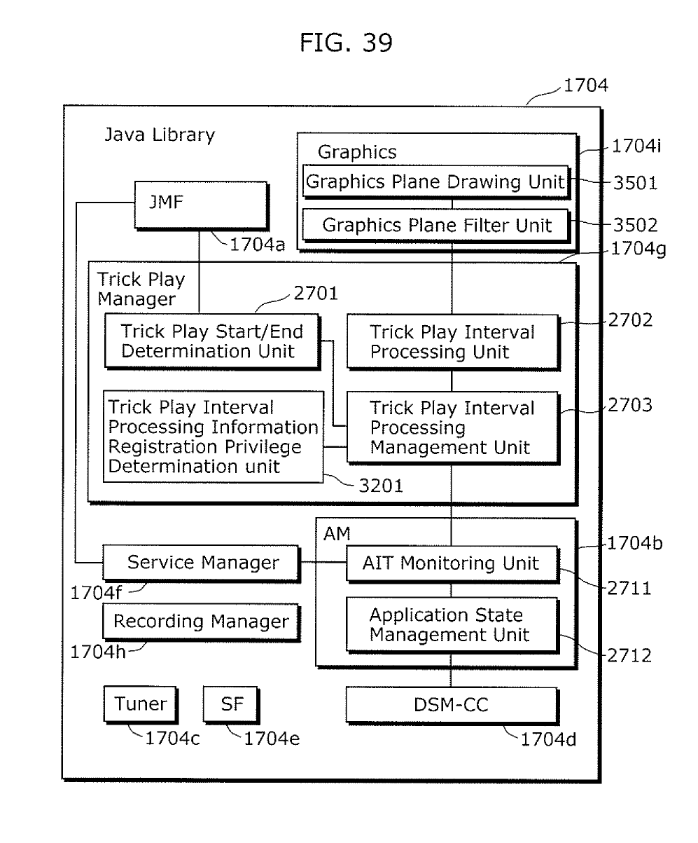

FIG. 39 is a diagram showing detailed configurations of the AM 1704b and the trick play manager 1704g in the Java library 1704.

The AM 1704b is configured of the AIT monitoring unit 2711 and the application state management unit 2712, as in the first embodiment. As the AIT monitoring unit 2711 has the same functions as in the second embodiment, descriptions are not repeated. As the application state management unit 2712 has the same functions as in the third embodiment, descriptions are not repeated.

The trick play manager 1704g is comprised of the trick play start/end determination unit 2701, the trick play interval processing unit 2702, the trick play interval processing management unit 2703 and the trick play interval processing information registration privilege determination unit 3201. As the trick play start/end determination unit 2701 and the trick play interval processing unit 2702 respectively have the same functions as in the third embodiment, descriptions are not repeated.

As in the third embodiment, the trick play interval processing management unit 2703 holds trick play interval processing information in which trick play start/end processing for a Java program is described, and also instructs the trick play interval processing unit 2702 to perform trick play start/end processing based on the trick play interval processing information. In the third embodiment, if an AIT is updated, the updated AIT is notified from the AIT monitoring unit 2711, and based on that AIT, an invisible flag in the held trick play interval processing information is updated. However, in the present embodiment, even if the AIT is updated, the updated AIT is not notified from the AIT monitoring unit 2711. The trick play interval processing management unit 2703 provides, as JavaAPI, a method “setInvisibleFlag(int appID, Boolean invisibleFlag)” having an invisible flag value as an argument.

Here, an argument appID is a Java program identifier to be set with an invisible flag value, and an argument invisibleFlag is an invisible flag value, When the setInvisibleFlag method is called by a Java program, the invisible flag in the held trick play interval processing information is updated. For example, setInvisibleFlag (301, true) is called by a Java program, the invisible flag corresponding to a Java program having a Java program identifier of “301” is set to “true”. On the other hand, setInvisibleFlag (301, false) is called by a Java program, the invisible flag corresponding to the Java program having the Java program identifier of “301” is set to “false”.

When the setInvisibleFlag method is called, the trick play interval processing management unit 2703 passes the identifier of a caller Java program to the trick play interval processing information registration privilege determination unit 3201, in order to determine whether or not the caller Java program has a privilege, that is a permission of updating an invisible flag. The trick play interval processing information registration privilege determination unit 3201 returns its determination result whether or not the Java program to which the identifier was passed has a privilege of updating the invisible flag.

If the determination result sent from the trick play interval processing information registration privilege determination unit 3201 indicates that the caller Java program does not have a privilege of updating the invisible flag, the trick play interval processing management unit 2703 returns the fact to the caller Java program. On the other hand, if the determination result indicates that the caller Java program has a privilege of updating the invisible flag, the trick play interval processing management unit 2703 saves trick play interval processing information including the invisible flag value at that point in time on a buffer, and sets the invisible flag value specified by the Java program thereto. Next, the trick play interval processing management unit 2703 determines whether or not the invisible flag value corresponding to the Java program has been changed. The trick play interval processing management unit 2703 compares the invisible flag value saved on the buffer and the invisible flag value included in the trick play interval processing information, and determines, based on the values before and after the update, whether the invisible flag value has been changed or not. Here, if the invisible flag value has not been changed, nothing is done. If the invisible flag value has been changed, the trick play interval processing management unit 2703 holds the changed value, and then determines whether or not trick play is in progress at the present moment based on the trick play flag in the trick play interval processing information. If the trick play flag value is “off” namely trick play is not in progress at the present moment, nothing is done. If the trick play flag value is “on” namely trick play is in progress at the present moment, the trick play interval processing management unit 2703 determines whether the invisible flag value has been changed from “true” to “false”, or from “false” to “true”.

In the former case, namely in the case where the invisible flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that invisible flag, and instructs the trick play interval processing unit 2702 to perform processing for displaying again the graphics drawn by the Java program which corresponds to that Java program identifier.

In the latter case, namely in the case where the invisible flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that invisible flag, and instructs the trick play interval processing unit 2702 to perform processing for hiding the graphics drawn by the Java program which corresponds to that Java program identifier.

The trick play interval processing information registration privilege determination unit 3201 determines whether or not the Java program corresponding to the specified Java program identifier has a privilege of updating the invisible flag in the trick play interval processing information. Upon receiving the Java program identifier passed from the trick play interval processing management unit 2703, the trick play interval processing information registration privilege determination unit 3201 determines whether or not the Java program corresponding to that Java program identifier has a permission for updating the invisible flag in the trick play interval processing information, and then, if it has the permission, permits the trick play interval processing management unit 2703 to update the invisible flag in the trick play interval processing information.

Here, the privilege, namely the permission to update the invisible flag in the trick play interval processing information can be set with, for example, MonitorAppPermission and the like in the OCAP specifications. This is a method in which a permission description file is also stored in a directory where a Java program is stored and a list of privileges permitted for the Java program is included in the permission description file. For example, if an application name of a Java program is described in a file named ocap.applicationname.perm in a format such as <ocap:monitorapplication name=“setInvisibleFlag” value=true></ocap:monitorapplication>, the Java program identified with such application name can have a privilege of updating an invisible flag in trick play interval processing information.

First, a Java program calls a setInvisibleFlag method provided by the trick play interval processing management unit 2703 in the trick play manager 1704g, and requests to set the invisible flag value in the trick play interval processing information. The trick play interval processing management unit 2703 passes, to the trick play interval processing information registration privilege determination unit 3201, the lava program identifier corresponding to the Java program which calls the setInvisibleFlag method, so as to determine whether or not that Java program has a privilege of updating the invisible flag. Here, if the Java program does not have a privilege of updating the invisible flag, the trick play interval processing information registration privilege determination unit 3201 returns the fact to the trick play interval processing management unit 2703, and ends the process. If the Java program has a privilege of updating the invisible flag, the trick play interval processing information registration privilege determination unit 3201 returns the fact to the trick play interval processing management unit 2703.

A typical process in the present embodiment having the above-explained configuration is described below using a flowchart.

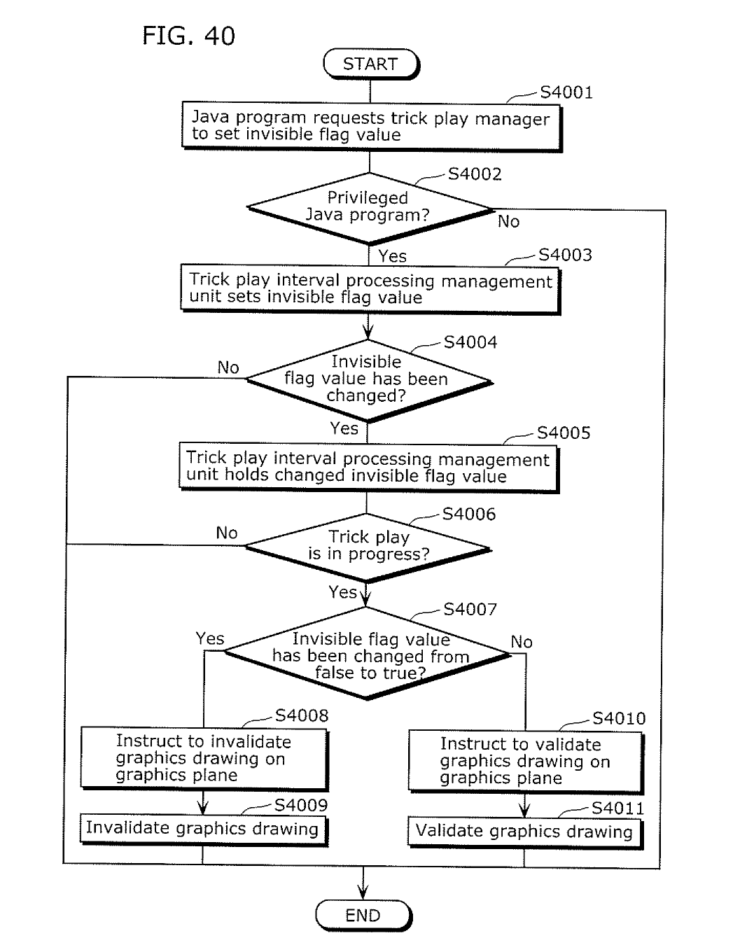

FIG. 40 is a flowchart showing the case where a Java program instructs the trick play manager 1704g to update an invisible flag in trick play interval processing information.

First, a Java program calls a setInvisibleFlag method provided by the trick play interval processing management unit 2703 in the trick play manager 1704g, and requests to set an invisible flag value in the trick play interval processing information (S4001). The trick play interval processing management unit 2703 passes, to the trick play interval processing information registration privilege determination unit 3201, the Java program identifier corresponding to the Java program which calls the setInvisibleFlag method, and determines whether or not that Java program has a privilege of updating the invisible flag (S4002). Here, if the Java program does not have a privilege of updating the invisible flag, the trick play interval processing information registration privilege determination unit 3201 returns the fact to the trick play interval processing management unit 2703, and ends the process. If the Java program has a privilege of updating the invisible flag, the trick play interval processing information registration privilege determination unit 3201 returns the fact to the trick play interval processing management unit 2703, and sets the invisible flag value specified by that Java program (S4303).

Here, the trick play interval processing management unit 2703 determines whether or not the invisible flag value corresponding to the Java program has been changed (S4004).

Here, in order to determine whether the invisible flag value has been changed or not, the trick play interval processing management unit 2703 saves the trick play interval processing information including the invisible flag value at that point in time into a buffer before updating it. The trick play interval processing management unit 2703 compares the invisible flag value saved on the buffer and the invisible flag value included in the trick play interval processing information, and determines, based on the values before and after the update, whether the invisible flag value has been changed or not. Here, if the invisible flag value has not been changed, nothing is done, If the invisible flag value has been changed, the trick play interval processing management unit 2703 holds the changed value (S4005), and then determines whether or not trick play is in progress at the present moment based on the trick play flag in the trick play interval processing information (S4006).

If the trick play flag value is “off”, namely trick play is not in progress at the present moment, nothing is done. If the trick play flag value is “on”, namely trick play is in progress at the present moment, the trick play interval processing management unit 2703 determines whether the invisible flag value has been changed from “true” to “false”, or from “false” to “true” (S4007). In the latter case, namely in the case where the invisible flag value has been changed from “false” to “true”, the trick play interval processing management unit 2703 passes, to the trick play interval processing unit 2702, the result indicating that trick play has started, namely, the trick play flag value of “on”, as well as the Java program identifier corresponding to that invisible flag, and instructs the trick play interval processing unit 2702 to perform processing for hiding the graphics drawn by the Java program which corresponds to that Java program identifier (S4008). The trick play interval processing unit 2702 calls, using the Java program identifier as an argument, an invalidate method provided by the graphics plane filter unit 3502, and instructs to invalidate the graphics drawing on the graphics plane 1314 by the Java program (S4009).

In the former case, namely in the case where the invisible flag value has been changed from “true” to “false”, the trick play interval processing management unit 2703 passes, to the trick play interval processing unit 2702, the result indicating that trick play has ended, namely, the trick play flag value of “off”, as well as the Java program identifier corresponding to that invisible flag, and instructs the trick play interval processing unit 2702 to perform processing for displaying again the graphics drawn by the Java program which corresponds to that Java program identifier (S4010). The trick play interval processing unit 2702 calls, using the Java program identifier as an argument, a validate method provided by the graphics plane filter unit 3502, and instructs to validate again the graphics drawing on the graphics plane 1314 by that Java program (S4011).

Since a flow of processes in the case of reproducing a service within an MPEG-2 transport stream recorded in the secondary storage unit 1307 is same as shown in the flowchart in FIG. 34, FIG. 34 is referred to here again, and descriptions are not repeated. Since a flow of processing performed by the trick play manager 1704g depending on a change in reproduction speed of an MPEG-2 transport stream is same as that in the third embodiment, the description is not repeated by referring to FIG. 37.

As described above, according to the fourth embodiment, graphics drawn by a Java program is hidden during trick play when an invisible flag is set, and thus it is possible to prevent distortion of, graphics drawn during trick play. In addition, since a Java program sets an invisible flag, it is possible to control the invisible flag more flexibly than the control of the invisible flag by AIT.

Some of the embodiments described above indicate the implementation examples of the present invention, but other embodiments can be implemented as long as the objects of the present invention are achieved.

In the embodiments, a configuration for a cable system has been shown, but the present invention can be applied independent of the type of a broadcast system. For example, the present invention can easily be applied to a satellite system, a ground wave system, or a TV show distribution system that uses an IP network. In addition, as the present invention has no direct relationship with the differences between respective broadcast systems, the present invention can be applied to an arbitrary transmission medium regardless of the broadcast system. The present invention is also applicable regardless of whether the system is a wired or wireless system.

It is not necessary for the AV decoder to decode video and

audio at the same time. The present invention can be implemented even if the AV decoder is configured as separate video and audio decoders. In addition, the AV decoder may have a decoding function for data such as closed captioning and the like without any interference The audio signal and video signal decoded by the AV decoder may be scrambled at any stage up until being stored in the recording area 1504.

In the embodiments, an example is given in which an adapter that controls conditional access system has been introduced, but the adapter is not always necessary for the implementation of the present invention. The adapter may be of any format, and a configuration without the adapter is also possible. In such a case, in FIG. 15, the MPEG-2 transport stream from the tuner is inputted directly into the TS decoder. The present invention is applicable in such a case as well. In addition, descrambling the MPEG-2 transport stream by the adapter does not necessarily have to be carried out before the TS decoder. A configuration in which the adapter is in an arbitrary position and is used to descramble the MPEG-2 transport stream is easily implementable, and the present invention is applicable in such a case as well.

Regarding an encoding format into which the AV encoder encodes the audio and video signal, an arbitrary format is acceptable. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of the display and speaker.

The present invention can be implemented even if the CPU itself is a system which performs multiple processes, the processes being all or some of TS decoding, AV decoding, AV encoding, and multiplexing.

As a format for recording the service, the MPEG-2 transport stream can also be recorded directly into the recording area after being outputted from the tuner, without going through the TS decoder; or, the format of the MPEG-2 transport stream from the tuner can be converted, by installing a translator that converts the format of the MPEG-2 transport stream, and recorded into the recording area. The present invention can be implemented regardless of the service recording method.

Some of the Java virtual machines translate the bytecode into an executable form which can be interpreted by the CPU and pass the resultant to the CPU, which executes it; the present invention is applicable in such a case as well.

The above embodiments describe a method for implementation regarding the AIT in which the transport stream is obtained from In-band; however, the method for referring to the Java program which the AM shall execute does not solely depend on the AIT. In OCAP, which is assumed to be used by the United States cable system, an XAIT, which has registered reference information of a Java program in the OOB denoted in FIG. 3, is used. In addition, methods such as starting a program pre-recorded in the ROM, starting a program downloaded and recorded in the secondary storage unit, and so on can be considered.

Although only some exemplary embodiments of this invention have been described in detail above, those skilled in the art will readily appreciate that many modifications are possible in the exemplary embodiments without materially departing from the novel teachings and advantages of this invention, Accordingly, all such modifications are intended to be included within the scope of this invention.

### INDUSTRIAL APPLICABILITY

According to the recording and reproduction apparatus and the recording and reproduction method of the present invention, in the case where a terminal reproduces a recorded content with trick play functionality, an application program is shifted to a paused state, or graphics drawing by the application program is temporarily canceled, even if the application program is executing time-consuming processing, or even if the application program is being executed on a terminal with low processing power. Therefore, it is possible to control unexpected behaviors of the application program. In addition, it is possible, particularly during fast-forward and rewind, to reduce the high-load access to a semiconductor memory or the like represented by a hard disk, a Blu-ray Disc (BD), a Digital Versatile Disc (DVD), a Secure Digital is (SD) memory card and the like, and thus to reduce the deterioration of such storage medium. Therefore, it is highly possible that the present invention is used particularly in the consumer electronics industry involving broadcast recording and reproduction apparatuses. For example, the present invention is applicable to cable STB, digital TV, and the like. Furthermore, the present invention is also applicable to devices with a broadcast receiving function, such as, for example, a cellular phone device and the like.

1. A recording and reproduction apparatus comprising:
a content reproduction unit operable to reproduce a content recorded on a storage medium;
a program execution unit operable to execute a program and to control a state of the program;
a content reproduction speed change unit operable to change a reproduction speed of the content based on an instruction from the program which is in an execution state;
a trick play detection unit operable to detect one of the following: that the reproduction speed has been shifted from a normal reproduction speed to a reproduction speed different from the normal reproduction speed; and that the reproduction speed has been shifted from a reproduction speed different from the normal reproduction speed to the normal reproduction speed; and
a trick play processing unit operable to instruct said program execution unit to change the state of the program based on the detection by said trick play detection unit,
wherein said program execution unit is operable to control the state of the program so that the state of the program is shifted to a state instructed by said trick play processing unit.

2. The recording and reproduction apparatus according to claim 1,
wherein when said trick play detection unit detects that the reproduction speed has been shifted from the normal reproduction speed to the different reproduction speed,
said trick play processing unit is operable to instruct said program execution unit to change the state of the program which is in the execution state to a paused state, and
said program execution unit is operable to pause the execution of the program so that the state of the program is shifted to the paused state.

3. The recording and reproduction apparatus according to claim 2,
wherein when said trick play detection unit detects that the reproduction speed has been shifted from the different reproduction speed to the normal reproduction speed,
said trick play processing unit is operable to instruct said program execution unit to change the state of the program from the paused state to the execution state, and
said program execution unit is operable to resume the execution of the program so that the state of the program is shifted to the execution state.

4. The recording and reproduction apparatus according to claim 1,
wherein said trick play processing unit is operable to instruct said program execution unit to change a state of a specific program only, the specific program being identified out of the programs.

5. The recording and reproduction apparatus according to claim 4,
wherein the specific program is identified based on information multiplexed into the content.

6. The recording and reproduction apparatus according to claim 4,
wherein the specific program is identified based on information which has previously been registered by a privileged program out of the programs.

7. A recording and reproduction apparatus comprising:
a content reproduction unit operable to reproduce a content recorded on a storage medium;
a program execution unit operable to execute a program and to control a state of the program;
a graphics display unit operable to control a mode of graphics between a visible mode and an invisible mode, the graphics being drawn by the program executed by said program execution unit;
a content reproduction speed change unit operable to change a reproduction speed of the content based on an instruction from the program;
a trick play detection unit operable to detect one of the followings. that the reproduction speed has been shifted from a normal reproduction speed to a reproduction speed different from the normal reproduction speed; and that the reproduction speed has been shifted from a reproduction speed different from the normal reproduction speed to the normal reproduction speed; and
a trick play processing unit operable to instruct said graphics display unit to change the mode of the graphics based on the detection by said trick play detection unit.

8. The recording and reproduction apparatus according to claim 7,
wherein when said trick play detection unit detects that the reproduction speed has been shifted from the normal reproduction speed to the different reproduction speed, said trick play processing unit is operable to instruct said graphics display unit to change the mode of the graphics from the visible mode to the invisible mode.

9. The recording and reproduction apparatus according to claim 8,
wherein when said trick play detection unit detects that the reproduction speed has been shifted from the different reproduction speed to the normal reproduction speed, said trick play processing unit is operable to instruct said graphics display unit to change the mode of the graphics from the invisible mode to the visible mode.

10. The recording and reproduction apparatus according to claim 7,
wherein said trick play processing unit is operable to instruct said graphics display unit to change a mode of only graphics drawn by a specific program identified out of the programs.

11. The recording and reproduction apparatus according to claim 10,
wherein the specific program is identified based on information multiplexed into the content.

12. The recording and reproduction apparatus according to claim 10,
wherein the specific program is identified based on information which has previously been registered by a privileged program out of the programs.

13. The recording and reproduction apparatus according to claim 1,
wherein the content and the program are information included in a broadcast wave and recorded onto the storage medium.

14. The recording and reproduction apparatus according to claim 7,
wherein the content and the program are information included in a broadcast wave and recorded onto the storage medium.
